(19) United States
(12) Patent Application Publication
(10) Pub. No.: US 2024/0291724 A1
(43) Pub. Date: Aug. 29, 2024

(54) Allocation of Resources to Process Execution in View of Anomalies

(71) Applicant: International Business Machines Corporation, Armonk, NY (US)

(72) Inventors: Avirup Saha, Kolkata (IN); Neelamadhav Gantayat, Bangalore (IN); Renuka Sindhgatta Rajan, Bengaluru (IN); Ravi Shankar Arunachalam, Bangalore (IN); Geomy George, Thrissur (IN); SAMPATH DECHU, Acton, MA (US)

(21) Appl. No.: 18/115,121

(22) Filed: Feb. 28, 2023

(51) Int. Cl. H04L 41/147; H04L 41/16

(52) U.S. Cl. CPC H04L 41/147; H04L 41/16

(57) ABSTRACT

Mechanisms are provided for forecasting information technology (IT) and environmental impacts on key performance indicators (KPIs). Machine learning (ML) computer model(s) are trained on historical data representing events and KPIs of organizational processes (OPs). The ML computer model(s) forecast KPI impact given events. Correlation graph data structure(s) are generated that map at least one of events to IT computing resources, or KPI impacts to OPs. A unified model is trained to model OPs and IT resources. The trained ML computer model(s) and unified model process input data to generate a forecast output that specifies at least one of a forecasted IT event or a KPI impact. The forecasted output is correlated with at least one of IT computing resource(s) or OP(s), at least by applying the correlation graph data structure(s) to the forecast output to generate a correlation output. A remedial action recommendation that comprises a resource allocation is generated based on the forecast output and correlation output.

### BACKGROUND

The present application relates generally to an improved data processing apparatus and method and more specifically to an improved computing tool and improved computing tool operations/functionality for performing allocation of resources to processes in view of anomalies and forecasting information technology (IT) and environment factor impacts on key performance indicators.

Key performance indicators (KPIs) are measurable values that determine how well an individual or organization is progressing towards their goals and objectives. Examples of KPIs may include, for example, number of orders processed, number of orders delivered, or other counts and/or statistical measures calculated from raw collected data. KPIs are used to monitor the health of a workflow and assist individuals at all levels of an organization to focus their work and efforts towards a common goal of the organization. While the organization and computing systems of an organization may gather many different measures, the KPIs are the key measurements used to determine if the organization is performing as desired and provides insights upon which decision making may be performed.

Many different computing tools have been developed for gathering data and generating/monitoring KPIs for various organizations. For example, IBM Sterling Supply Chain Insights™ with IBM Watson™, available from International Organization Machines (IBM) Corporation of Armonk, New York, provides KPIs related to the health of a supply chain, covering areas of supply, sales orders, and delivery. Many of these computing tools have default sets of KPIs but also permit users to define their own custom KPIs for the particular individual, organization, or the like. Moreover, many of these systems provide graphical user interface outputs that allow users to view a representation of the current status of KPIs at a glance and receive alerts based on these KPIs and defined performance goals.

In addition, various computing systems have also been developed for monitoring performance of information technology (IT) systems, i.e., monitoring the operational state of the underlying data processing systems, computing devices, storage systems and devices, network systems and devices, software applications, and the like, collectively referred to as IT resources. For example, a storage system may be monitored with regard to available disk space and may generate warning events when the available disk space is determined to be low. Network bandwidth may be monitored by performance monitoring computer systems to determine when available bandwidth is being overutilized or underutilized and corresponding alerts may be generated. Such alerts may be triggered due to pre-determined IT service level agreements (SLAs), for example, and may then lead to the creation of incidents that are then resolved by IT teams in order to comply with the IT SLAs.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises executing machine learning training of one or more machine learning (ML) computer models based on historical data representing logged events and key performance indicators (KPIs) of organizational processes, where the one or more ML computer models are trained to forecast a KPI impact given events in the input data. The method further comprises generating at least one correlation graph data structure that maps at least one of events to IT computing resources, or KPI impacts to organizational processes. The method also comprises generating a unified model of organizational processes and IT resources, where the unified model executes to predict affected IT resources given a KPI impact to an organizational process. In addition, the method comprises processing, by the one or more trained ML computer models and the unified model, input data to generate a forecast output, wherein the forecast output specifies at least one of a forecasted IT event or a forecasted KPI impact. Furthermore, the method comprises correlating the forecasted output with at least one of an IT computing resource or an organizational process, at least by applying the at least one correlation graph data structure to the forecast output to generate a correlation output. The method also comprises generating a remedial action recommendation based on the forecast output and correlation output, where the remedial action recommendation has an associated resource allocation.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram that illustrates an example of a computing environment that is capable of implementing an information technology failure (ITF) impact prediction framework in accordance with one illustrative embodiment;

FIG. 2 is an example diagram that illustrates an example architecture for an executable ITF impact prediction framework in accordance with one illustrative embodiment;

FIG. 3 is an example diagram that illustrates an example method of operation of the ITF impact prediction framework in accordance with one illustrative embodiment;

FIG. 4 is an example diagram that illustrates an example of the mapping of an unseen IT failure and the generation of an impact prediction and recommendation as performed by the unseen event handler in accordance with one illustrative embodiment;

FIG. 5 is an example diagram that illustrates an example of the key performance indicator (KPI) mapping and the impact prediction and recommendation generation as performed by the unseen event handler and impact profile matching engine in accordance with one illustrative embodiment;

FIG. 6 is an example diagram that illustrates an example of the generation of a unified process-IT topology as performed by the unified topology generator in accordance with one illustrative embodiment;

FIG. 7 is an example diagram that illustrates an example process IT combination for which an example unified process-IT topology is generated by the unified topology generator in accordance with one illustrative embodiment;

FIG. 8 is an example diagram that illustrates portions of the example unified process-IT topology generated by the unified topology generator in accordance with one illustrative embodiment;

FIG. 9 is an example block diagram illustrating the primary operational components of an organizational performance (OP) and information technology (IT) correlation based forecasting computer tool during offline training in accordance with one illustrative embodiment;

FIG. 10 is an example diagram illustrating an example IT correlation graph in accordance with one illustrative embodiment;

FIG. 11 is an example block diagram illustrating the primary operational components of an OP-IT forecasting and resource allocation computing system during online operations in accordance with one illustrative embodiment;

FIG. 12 is an example diagram showing a correlation of OP operation metrics with IT events over time and the determination of a key performance indicator impact based on such a correlation, in accordance with one illustrative embodiment;

FIG. 13 is a flowchart outlining an example operation for performing offline training of the OP-IT forecasting computing system in accordance with one illustrative embodiment;

FIG. 14 is a flowchart outlining an example operation for performing online forecasting by way of the OP-IT forecasting computing system in accordance with one illustrative embodiment;

FIG. 15 is a flowchart outlining an example operation for performing remediation action planning based on forecasting from an OP-IT forecasting computing system in accordance with one illustrative embodiment;

FIG. 16 is a flowchart outlining an example operation for performing organizational staff allocation based on predicted OP and KPI impacts in accordance with one illustrative embodiment;

FIG. 17 if a flowchart outlining an example operation for allocating non-human organizational resources based on predicted OP and KPI impacts in accordance with one illustrative embodiment;

FIG. 18 is a flowchart outlining an example operation for allocating IT SREs based on predicted OP and KPI impacts in accordance with one illustrative embodiment; and

FIG. 19 is a flowchart outlining an example operation for allocating IT resources based on predicted OP and KPI impacts in accordance with one illustrative embodiment.

### DETAILED DESCRIPTION

While computing systems have been developed to monitor performance of an organization with regard to predefined key performance indicators (KPIs), and computing systems have been developed to monitoring the health and operation of information technology (IT) computing resources, these systems operate in silos, i.e., separate and disconnected from each other. There is currently no automated computing tool mechanism that facilitates an understanding of how the IT operations and issues in IT resources impact the organizational performance KPIs. That is, while IT teams may utilize computing tools to monitor the IT resources of an organization's computing and data storage environments, this monitoring and resolution of issues that the IT teams may be made aware of is separate and distinct from any monitoring of KPIs through corresponding KPI monitoring systems, which is more of an organizational performance concern than an IT concern. For example, while an IT team may receive alerts and resolve the corresponding incidents when the alerts are triggered, the IT team does not know the organizational performance impact of these IT alerts, or the potential corresponding organizational performance based incidents/problems that gave rise to the IT alerts, and thus, cannot prioritize the resolution of such issues based on the organizational performance impact, such as may be measured by KPIs. There is a disconnect between IT incident handling by IT teams and higher level organization or organizational performance level concerns measured by KPIs.

It should be appreciated that, while IT monitoring systems may be able to prioritize alerts, such prioritization is performed with regard to predetermined service level agreements (SLAs) or computer resource performance criteria that does not reflect how IT problems impact KPIs, or how issues at the organizational performance level, such as those measured by KPIs, impact IT systems and resources. For example, IT monitoring systems and KPI monitoring systems cannot evaluate or forecast how, if hard disk storage is allowed to be left higher than a threshold, this would impact the organization's KPIs. As another example, IT monitoring systems and KPI monitoring systems cannot evaluate or forecast how, if IT teams took 6 hours to clear the disk space instead of 4 hours, this would impact the organization's KPIs. In yet another example, IT monitoring systems and KPI monitoring systems cannot evaluate how much organizational performance KPI impact was averted due to automated resolution of disk space issues. In short, there are no automated computing tools that can reason over IT monitoring metrics and KPI measurements and provide reliable forecasting of the impact of IT computing resource status on organizational performance KPIs, or vice versa, and automatically generate remedial action recommendations based on this forecasted impact.

The same is true of other non-IT events which may have an impact on KPI measurements. For example, various organizational and environmental events may have significant impacts on KPIs by affecting IT resources and organizational processes. For example, labor strikes, weather, disease, governmental shutdowns, and the like, may all impact various operational capabilities of organizations and impact KPIs, e.g., in an organization shipping products, weather may cause significant impacts on the ability to move products along particular shipping routes and affect KPIs. Similarly, labor shortages at various points along the product shipping lanes may impact KPIs.

The illustrative embodiments provide an improved computing tool and improved computing tool functionality having artificial intelligence providing unified organizational process-IT topologies and causal models for impacts of events on KPIs, as well as artificial intelligence to perform impact analysis along various dimensions to generate remedial action recommendations with corresponding resource allocations. That is, the illustrative embodiments provide computer tools to generate a unified model that correlates organizational processes with IT infrastructure so that the impact of events on organizational processes may be correlated with effects on IT infrastructure, and vice versa. In addition, the illustrative embodiments provide computer tools to generate causal models that correlated the impact of events on KPIs. Thus, given an event, the effect of the event on KPIs may be determined, and the effect on the KPIs may be correlated with organization processes and/or IT infrastructure, which can then be correlated with the other organization processes and/or IT infrastructure. One or more impact analyzers provide computing tools to analyze the unified model and causal model, given a stream of IT, organizational, and/or environmental events and/or a KPI stream, to generate one or more recommended remedial actions having associated organizational and/or IT resource allocations. In this way, the improved computing tool and improved computing tool functionality determines an optimal remedial action and corresponding allocation of resources to obtain a maximum beneficial effect on KPIs with minimal resource cost based on the predicted impact of events given the unified model and causal model.

The following description will first be directed to describing the mechanisms for generating predictions of event impacts based on the unified model, which correlates organizational processes (OPs) with IT infrastructure components, where these IT infrastructure components may be physical (e.g., computer hardware, computing devices, memories, processors, etc.) and/or virtual components (e.g., software, data structures, etc.). In some cases, the IT infrastructure components may be human resources, such as site reliability engineers (SREs) or other IT personnel. The description will then discuss the generation of the causal model that models the impact of events, e.g., IT events and non-IT events as discussed hereafter, on KPIs. Thereafter, the description will focus on the operation of the impact analyzer(s) and the generation of a remedial action recommendation and allocation of resources based on the unified model, causal model, and prediction of impacts of events on KPIs, organizational processes, and IT infrastructure.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

It should be appreciated that the illustrative embodiments described herein generate and utilize various “models”. The term “model” or “computer model” as used herein refers to a representation of a system or process created on a computer, to assist calculations and predictions. Thus, the term “model” is specific to computer technology and refers to models that exist within a computing device and computing environment. In the illustrative embodiments, the “model” or “computer model” is a data and/or computer logic representation, and in many cases are probabilistic models, deep learning neural network models, or the like. These models may be trained through machine learning processes for generating predictions or classifications and thus, may be referred to as machine learning (ML) models or computer models herein.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As described above, the illustrative embodiments of the present invention are specifically directed to an improved computing tool and improved computing tool functionality that automatically predicts/forecasts organization performance (OP) impacts and information technology (IT) infrastructure impacts of events based on a machine learning training of one or more machine learning models, correlation of such impacts with specific OP operations and IT computing resources, and automatically generates remedial action recommendations (and corresponding resource allocations) based on the correlations. All of the functions of the illustrative embodiments as described herein are intended to be performed using automated processes without human intervention. While a human being may benefit from the operation of the illustrative embodiments, the illustrative embodiments of the present invention are not directed to actions performed by the human being, but rather computer logic and functions performed specifically by the improved computing tool, including operation of specifically trained machine learning computer model(s) and logic that performs the functions for the generation and application of correlation data structures to specifically identify impacted IT computer resources and OP operations, such as may be evaluated using key performance indicators (KPIs). While the illustrative embodiments may generate an output that ultimately assists human beings in performing decision making, the illustrative embodiments of the present invention are not directed to actions performed by the human being viewing the results of the processing performed by the improved computing tool, but rather to the specific operations performed by the specific improved computing tool of the present invention, which are operations that cannot be practically performed by human beings apart from the machine learning computer model mechanisms, correlation graph data structure and application logic, and other improved computing tool operations/functionality described herein. Thus, the illustrative embodiments are not organizing any human activity, are not simply implementing a mental process in a generic computing system, or the like, but are in fact directed to the improved and automated computer logic and improved computer functionality of an improved computing tool.

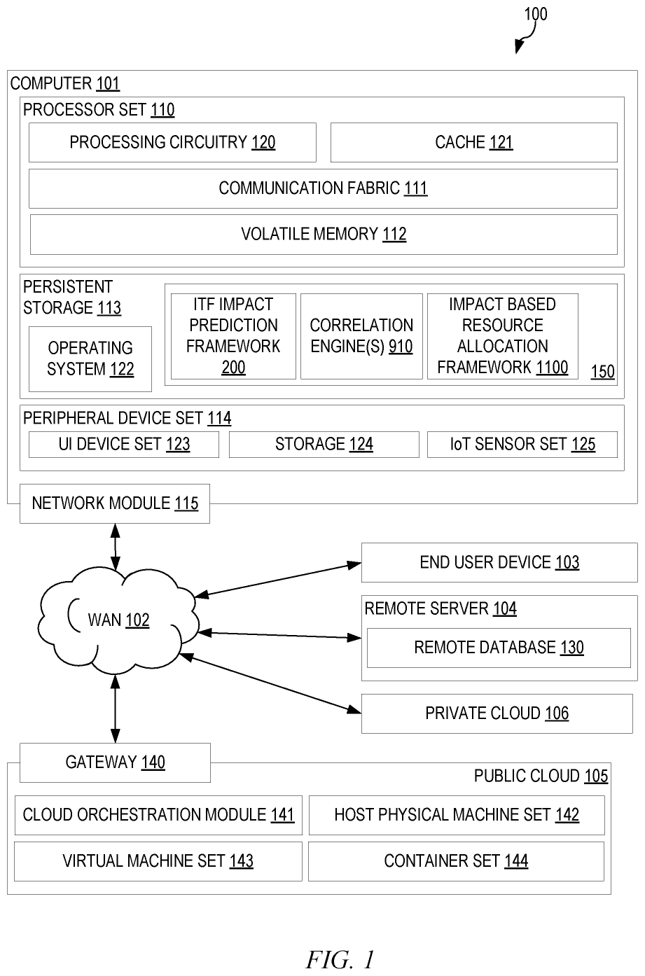

FIG. 1 is an example diagram of a distributed data processing system environment in which aspects of the illustrative embodiments may be implemented and at least some of the computer code involved in performing the inventive methods may be executed. Computing environment 100 is an example of an environment for the execution of at least some of the computer code in block 150 involved in performing the inventive methods, such as information technology failure (ITF) impact prediction framework 200, correlation engine(s) 910, and an impact based resource allocation framework 1100, implemented as one or more executable program codes or instructions. ITF impact prediction framework 200 is capable of determining the impact of unseen IT failures based on a unified mode of organizational process (OP)-IT topology. Determination of the impact on one or more process KPIs, for example, can dictate a redeployment and/or reconfiguration of IT resources using IT SRE techniques, which can avoid or mitigate a loss of organization and/or revenues. With the ITF impact prediction framework 200, a likely root cause of the IT failure can be discovered and resolution histories from previously seen IT failures extracted for remedying or limiting the impact of the unseen IT failure. With the correlation engine(s) 900, correlations between organizational processes and KPIs, and events and IT resources, are learned. The impact-based resource allocation framework 1100 is capable of determining resource allocations, along a variety of dimensions, based on the predicted impacts of events on KPIs, organizational processes, and the IT infrastructure, and providing one or more remedial action recommendations and corresponding resource allocations based on a maximizing of beneficial results on KPIs balanced with resource allocation costs.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ITF impact prediction framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an organization that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single organization. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a ITF impact prediction framework 200, one or more correlation engines 910, and an impact based resource allocation framework 1100, which may operate in accordance with one or more of the illustrative embodiments previously described above. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates forecasting events and KPI impacts and generating remedial action/IT resolution recommendations based on these forecasted events and KPI impacts, as well as performing resource allocations based on the determined remedial actions/IT resolution recommendations. These recommendations may be utilized to focus and prioritize IT resources to those events and KPI impacts that will most benefit the organization and provide the optimum benefit versus cost. Moreover, in some cases, the remedial actions and/or IT resolutions may be automatically initiated and executed, if possible.

### IT Failure (ITF) Impact Predictions Based on Unified Model of Organizational Processes and IT Topology

As discussed above, one aspect of the illustrative embodiments is to build a unified model of organizational process (OP)-IT topology so that this unified model may be used to predict the impact of IT failures (ITFs), both seen and unseen, on organizational processes and KPIs, and in some cases vice versa, i.e., events affecting organizational processes and KPIs and how those may impact IT infrastructure. Thus, it is beneficial to have an understanding of example illustrative embodiments that generate such a unified model. The example illustrative embodiments for generating the unified model of the OP-IT topology corresponds to commonly assigned and co-pending U.S. patent application Ser. No. 18/064,069 (Attorney Docket No. P202202148US01), entitled “Predicting the Impact of Previously Unseen Computer System Failures on the System Using a Unified Topology”, filed Dec. 9, 2022, which is hereby incorporated herein by reference.

As touched upon above, organizations (e.g., business enterprises, governmental agencies, and the like) of all sizes increasingly rely on information technology (IT) systems to carry out a wide array of activities. Accordingly, it can be critical that, when an IT failure (ITF) occurs, the organization utilizing the IT system (i.e., the computing system or systems used to facilitate organizational processes, also referred to herein as the IT infrastructure) responds rapidly and accurately to the ITF. An optimal response, however, requires that the organization have at least some awareness of the root cause and future impact of the ITF. If the ITF is one not previously seen, however, it may be very difficult for the organization to learn the root cause or future impact of the ITF.

In accordance with the illustrative embodiments described herein, methods, systems, and computer program products are provided that are capable of determining the impact of an unseen ITF based on a unified organizational process (OP)-IT topology. The unified model of the OP-IT topology, or “unified model” as defined herein, is a description of the interrelationship among the steps of one or more defined organizational processes, e.g., insurance claim processing, and specific IT events (e.g., API calls) executed by an IT system (or infrastructure) in performing automated functions that carry out the process steps. As defined herein, “IT event” is an automated action, process, or function performed by an IT system. For example, many IT events include an API call, which instantiates or invokes the action, process, or function.

As defined herein, “IT failure” or ITF is a machine-generated error that causes a result that is incorrect, unintended, or less optimal than expected by an IT system user or causes a cessation of all or a portion of the processes executed by the IT system. Thus, the error can affect an automated function performed by the IT system, and accordingly, can cause a corresponding failure or suboptimal performance of the process step supported by the automated function. “Unseen IT failure,” as defined herein, is an ITF that the IT user has not previously encountered and has no, or only limited, current knowledge of.

By aligning and linking IT events with the steps of an organizational process (OP) that the IT system supports into a unified model of the OP-IT topology, the illustrative embodiments described herein can detect and predict the impact of an ITF on the process or processes supported by the IT system, and can determine the impact of events affecting the processes on the IT system. The processes may be any organizational process that is performed using IT infrastructure, such as data processing systems and networked data processing systems. As defined herein, the IT infrastructure is the software architecture that operatively combines software elements (e.g., IT services and applications) that perform specific actions, processes, and functions, as well as the computer hardware on which the software elements are executed. The unified model of the OP-IT topology is based on the integration of the process steps and the various IT services and applications of an IT infrastructure that support a process.

The illustrative embodiments may be used, for example, to determine the impact of an unseen ITF on key performance indicators (KPIs) corresponding to the process. Determination of the ITF's impact (e.g., on one or more process KPIs) can dictate a redeployment and/or reconfiguration of IT resources using IT site reliability engineering (SRE) techniques, thereby mitigating the impact of an ITF. The illustrative embodiments can discover a likely root cause of the ITF, as well as extract resolution histories that effectively and efficiently dealt with previously seen ITFs that are similar. The resolution histories, as applicable, can be integrated into a set of predictions and recommendations generated by the illustrative embodiments for remedying the unseen ITF, or at least lessening its impact. In the specific context of organization processes supported by an IT system, for example, the more rapidly and accurately an ITF is diagnosed and corrected, the less likely is a loss of organization services and/or loss in revenues.

In one aspect, the illustrative embodiments overcome challenges to generating a unified model of the topology for a process (e.g., organization process) and the IT infrastructure supporting the process. One challenge is that process logs and IT logs are generated at different stages of the process. For example, process logs record performance of the steps of the process and are generated after execution of the API calls and other IT events, which typically are logged in real, or near-real, time in an IT log separate from the log of process steps. Both the process log and IT log, moreover, typically use different data structures and terminologies for the same or similar event. Another challenge is asynchronous process execution, in which different event instantiations occur at different stages, thus precluding or limiting temporal clustering and making it difficult to achieve a one-to-one correspondence between process steps and corresponding API calls and/or other IT events. Organization processes, moreover, often have parallel process paths that are asynchronous. For example, a process for handling insurance claims may entail two simultaneous steps-customer verification and claim amount verification—that are independent and asynchronous in nature. Yet another challenge is in linking API calls and process logs owing to terminology differences (e.g., API names are typically very generic), which precludes or limits using semantic similarity to link and align API names and process steps. The data contained within an API call (the payload) also may lack sufficient detail for linking the API call and process log.

The unified model of the organizational process (OP)-IT topology introduced in the illustrative embodiments disclosed herein overcomes these challenges. In one aspect, the unified model provides a local clustering for grouping events (API calls with process log entries) related to the same process step, and a higher-level (global) clustering for grouping, as feasible, local clusters in both the IT and event streams. Global clustering provides a second-order clustering into groups that contain local clusters from both domains. In another aspect, the unified process-IT topology combines temporal and semantic (event-related) features. Temporal features enable the grouping of events from different streams with large time differences in the same global cluster, notwithstanding large time lags between events recorded in both IT and process logs. Moreover, the local and global clustering can encompass continuous (e.g., real) time as well as, or alternatively to, discrete time. A combined and flexible approach to clustering of multi-event streams in continuous time is an aspect largely lacking with conventional process monitoring and IT monitoring, especially in the context of combining the two.

In another aspect, the illustrative embodiments assess the impact of ITFs. An observed but previously unseen ITF's impact can be assessed based on the uniform process-IT topology.

In yet another aspect, an unobserved ITF can be assessed based on impact profile matching. The profile matching can determine the likely root cause and future impact of the ITF.

In still another aspect, the illustrative embodiments can recommend one or more remediations to mitigate or lessen the impact of the ITF.

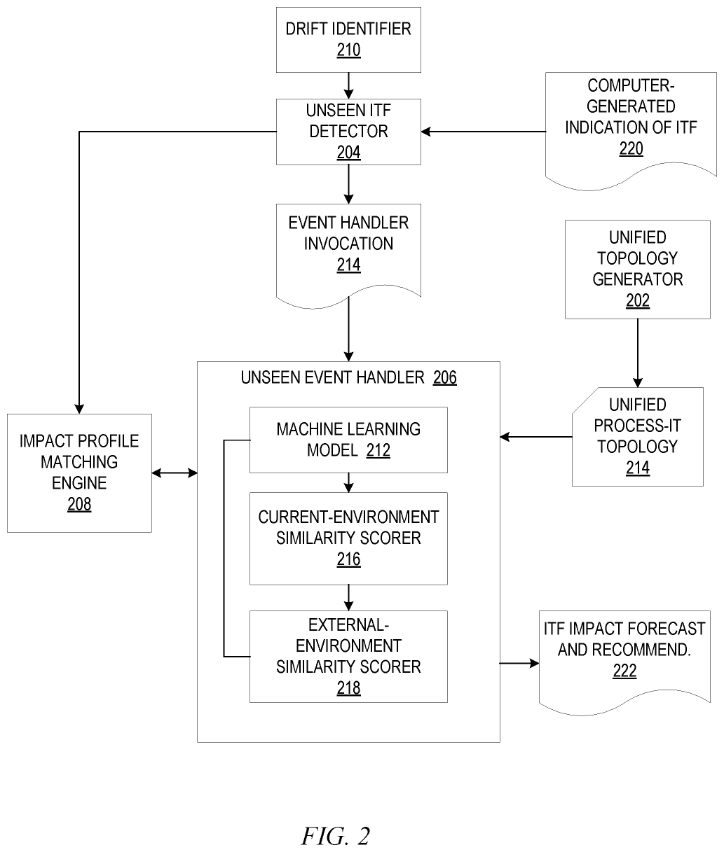

FIG. 2 is an example diagram that illustrates an example architecture for the executable ITF impact prediction framework 200 in accordance with at least one illustrative embodiment. Illustratively, in FIG. 2, the example architecture of the ITF impact prediction framework 200 includes a unified topology generator 202, an unseen ITF detector 204, an unseen event handler 206, and an impact profile matching engine 208. The example architecture of the ITF impact prediction framework 200 optionally includes a drift identifier 210. In certain illustrative embodiments, the unseen event handler 206 implements a machine learning (ML) model 212. The ML model 212 is trained based on a unified organizational process (OP)-IT topology 214, which is generated by the unified topology generator 202. Additionally, in certain illustrative embodiments, unseen event handler 206 also implements a current-environment similarity scorer 216 and an external-environment similarity scorer 218. The operation an interaction between these elements of the ITF framework 200 will be described in greater detail hereafter.

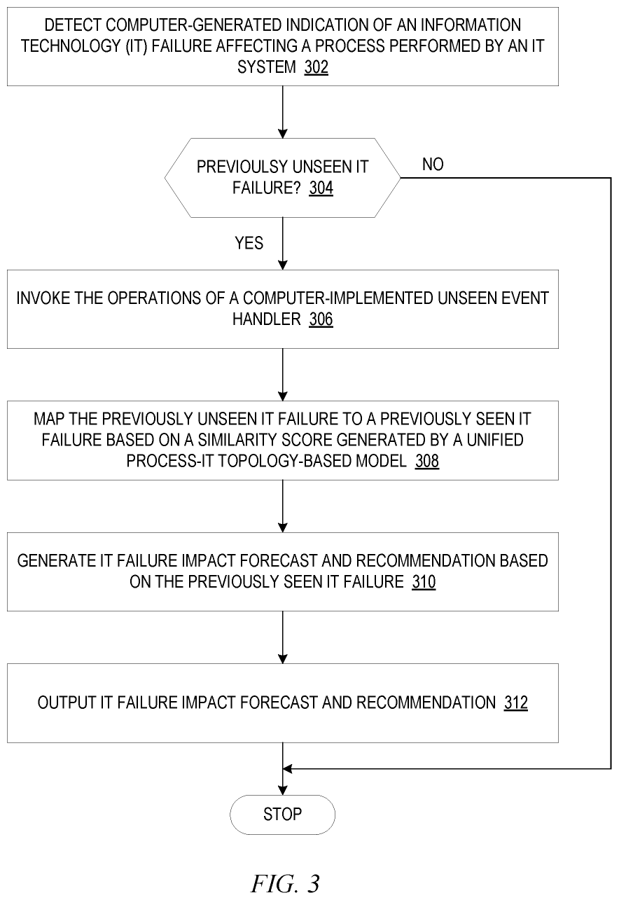

FIG. 3 is an example diagram that illustrates an example method 300 of operation of the ITF framework 200 in accordance with one or more illustrative embodiments. Referring to FIGS. 2 and 3 collectively, in block 302, the unseen ITF detector 204 detects computer-generated indication 220. Computer-generated indication 220 can be generated by a computer or other device that is part of an IT system, such as an organization IT system, to which unseen ITF detector 204 is communicatively coupled via a wired or wireless connection. The computing device can generate computer-generated indication 220 in response to a failure of one or more IT services, IT applications, or other elements of an IT infrastructure.

In block 304, the unseen ITF detector 204 is capable of determining whether the ITF indicated by computer-generated indication 220 is one previously encountered by the affected IT system or is otherwise known to the system. In certain illustrative embodiments, the unseen ITF detector 204 determines whether the ITF is a previously seen ITF by automatically searching a database that electronically stores data corresponding to previously seen ITFs. The data can comprise a data structure that records certain parameters corresponding to the previously encountered ITF. If the unseen ITF detector 204's automatic database search fails to detect a match or similarity between a previously encountered ITF and that indicated by the computer-generated indication 220 in block 304, then in block 306, the unseen ITF detector 204 invokes operations of the unseen event handler 206 via unseen event handler invocation 214.

In block 308, the unseen event handler 206 is capable of mapping the previously unseen ITF to a previously seen ITF. The unseen event handler 206 maps the previously unseen ITF to the previously seen ITF based on a similarity score. Depending on circumstances described below, the similarity score is generated by either the current-environment similarity scorer 216 or the external-environment similarity scorer 218. Both the current-environment similarity scorer 216 and the external-environment similarity scorer 218 compute a similarity score using the same procedure but with reference to different databases.

In certain illustrative embodiments, the current-environment similarity scorer 216 and the external-environment similarity scorer 218 can be configured to generate a vector for an IT alert. The vector may be based on the attributes (context) of the error, such a HTTP error, database error, or server-down condition, for example, as well as other attributes of the IT infrastructure. The similarity between two IT alerts is based on a vector representation of the respective IT systems impacted. The elements of each vector representation of an IT alert correspond to a specific IT system attribute (e.g., database, application instance), each element having a value of one if the IT system attribute is present or a zero value otherwise. A weighted dot product of the vectors is computed. The similarity score is determined by the cosine similarity between the vectors. Weights are relatively higher for a current-environment score than for an external-environment score. Unseen event handler 206 maps computer-generated indication 220 to the previously seen ITF corresponding to an IT alert having the greatest similarity score. That is, the greatest similarity corresponds to the highest cosine similarity between the vector representation the previously unseen IT alert and the vector representation of the previously seen IT alert corresponding to the previously seen ITF.

In block 310, the machine learning model 212 is capable of generating an ITF impact prediction and recommendation 222. The machine learning model 212 generates the ITF impact prediction and recommendation 222 based on the previously seen ITF having the greatest similarity score. In certain illustrative embodiments, the machine learning model 212 generates the ITF impact prediction and recommendation 222 using, as input, the parameters of the previously seen ITF. The machine learning model 212 is trained to predict an impact of the ITF, and based on the predicted impact, recommend one or more actions to avoid or mitigate the impact of the ITF.

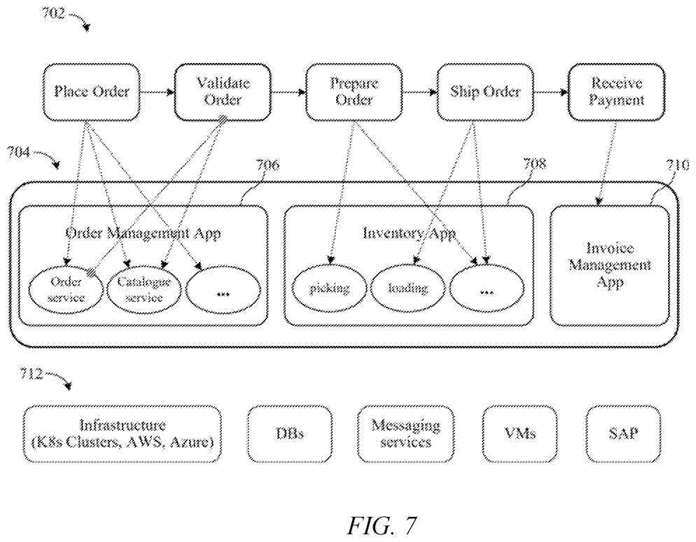

In certain illustrative embodiments, the machine learning (ML) model 212 is a probabilistic model or a deep learning neural network that is trained to associate, based on unified organizational process (OP)-IT topology 214, likely impact of the ITF on one or more processes and/or one or more specific process steps, and thus, may be considered a unified model 212 operating on a unified OP-IT topology 214. The unified OP-IT topology 214, as described in greater detail below, clusters steps from a process into distinct groups and matches, both temporally and semantically (event-related), each of the clusters or groups with specific IT events (e.g., API calls) of the IT system that support the process steps. For example, the one or more processes may be an organization process supported by an organization IT system that is adversely affected by a failure of the organization IT system (see, e.g., FIG. 7). The impact of the ITF predicted by the machine learning model 212 can pertain to a specific process step or steps that are likely to be affected by the ITF and how each process step is likely to be affected. In some embodiments, the prediction is a likely change in one or more KPIs that measure performance of the process, the change being due to the ITF. An example machine learning algorithm used for clustering using both temporal and semantic similarities is the Hierarchical Dirichlet Gaussian Marked Hawkes Process, described in greater detail below.

The impact profile matching engine 208, in some embodiments, matches the computer-generated indication 220 to an impact profile of a previously seen ITF having the greatest similarity score. The similarity between KPI impacts of two IT alerts can be determined based on a statistical correlation, where the determination of IT alert similarity is based on impacted IT system attributes. Thus, a matching is applicable to both KPI impact as well as ITFs, though the matching process can be implemented differently.

The impact profile can include a root cause analysis (RCA) that corresponds to the previously seen ITF and that, based on the determined similarity, has applicability to the unseen ITF. The RCA can be included in the ITF impact prediction and recommendation 222. Remedial actions that proved successful in correcting or mitigating the effect of the previously seen ITF can also be included in the impact profile identified by the impact profile matching engine 208. The remedial actions likewise can be incorporated in an ITF impact prediction and recommendation 222. In block 312, the unseen event handler 206 outputs the ITF impact prediction and recommendation 222.

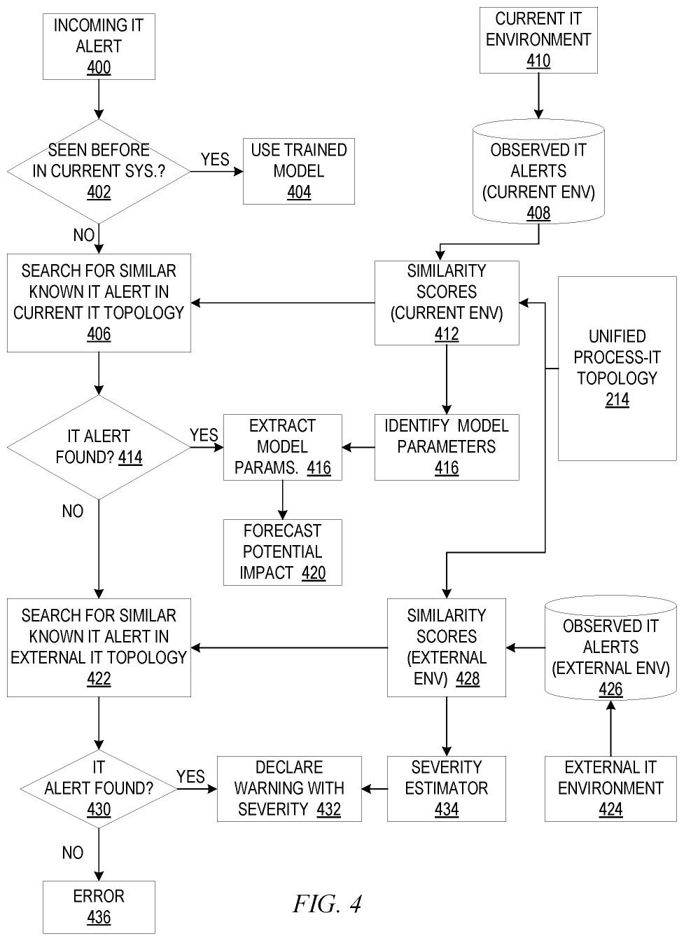

FIG. 4 is an example diagram that illustrates an example of the mapping of an unseen ITF and the generation of an ITF impact prediction and recommendation as performed by the unseen event handler 206, in accordance with one or more illustrative embodiments. In the example of FIG. 4, the unseen ITF detector 204 has determined that the ITF, indicated by computer-generated indication 220, is an IT alert shown as incoming IT alert 400. In block 402, the unseen ITF detector 204 determines whether the IT alert 400 is a previously seen IT alert. If so, then in block 404, a trained computer model (not shown) is used to identify the corresponding ITF and generate an appropriate response (impact prediction and recommendation).

If in block 402, the unseen ITF detector 204 determines that the IT alert 400 is a previously unseen IT alert, then in block 406 the unseen event handler 206 searches for a similar, known (previously seen) IT alert given the current IT topology (unified OP-IT topology 214) generated by unified topology generator 202. The search is for an IT alert, previously observed and electronically stored in a database of observed IT alerts 408, which corresponds to the current IT environment 410. The current IT environment 410 comprises the various IT services, applications, and other software elements of the IT infrastructure that collectively support one or more processes used by the entity, such as an organization or governmental entity, that operates the underlying IT system. The search at block 406 is based on similarity scores 412 of observed IT alerts 408 with respect to the IT alert 400, the similarity scores being generated by the current-environment similarity scorer 216 of the unseen event handler 206.

If at block 414, the unseen event handler 206 finds a previously seen IT alert, then the unseen event handler 206 in block 416 identifies model parameters associated with the previously seen IT alert for input to the ML model 212 for predicting the impact of the underlying ITF. The ML model 212 can be implemented by a vector autoregression, XGBoost, long short-term memory (LSTM) neural network, or other machine learning algorithm. Machine learning model 212 predicts the impact of the IT alert on the KPIs. The model parameters of the machine learning model are numbers, tensors, numerical weights, or biases that define the machine learning model. In the present context, the model parameters are inherited from models trained using previously seen alerts because no data is available for training a model for an unseen alert. The inherited model parameters are the ones identified in block 416.

In block 418, the parameters of the previously seen IT alert are extracted from the previously seen IT alert and input to the ML model 212 of the unseen event handler 206 for forecasting the impact of the previously unseen incoming IT alert 400. Thus, in block 420, the unseen event handler 206 predicts the potential impact based on the parameters obtained from the previously seen IT alert determined to be similar. For example, a parameter of the previously seen IT alert that indicates how long a corresponding ITF is likely to last, and which process steps are affected (based on unified process-IT topology 214), can enable the ML model 212 to predict how long a similar failure is likely to last, which steps are affected, and accordingly, how long until those steps of the process can resume.

If at block 414, the unseen event handler 206 fails to find a previously seen IT alert, then the unseen event handler 206 in block 422 searches for a similar known (previously seen) IT alert from an external environment. An external environment includes any IT services, applications, software infrastructure elements, and the like, other than that currently utilized by the organization whose processes run on the IT system affected by the ITF. For example, if the organization operates using one set of organization or other software, then that defines the internal environment, and any different set of organization or other software is therefore an external environment.

Thus, not having found a current-environment IT alert, the unseen event handler 206 searches for IT alerts from an external IT environment 424, and the IT alerts built on information available from the other environments. A database of observed IT alerts 426 from the external environment is searched by the unseen event handler 206. The unseen event handler 206 performs the search based on similarity scores 428 of observed IT alerts 426 with respect to the IT alert 400. If in block 430, a similar previously seen IT alert is found by the unseen event handler 206, then at block 432, the unseen event handler 206 declares a warning indicating a specified severity. The severity can be determined by the severity estimator 434. The severity estimator 434 determines the severity based on the parameters of the similar previously seen IT alert. Severity estimator 434 measures the degree to which an IT alert, which occurred as a result of the previously seen ITF, impacts the KPI(s). Accordingly, if a similar IT alert is found based on the external-environment similarity score, then the severity estimate can be given based on the observed KPI impact (e.g., high/medium/low) within the external environment. A severity estimate is used in instances in which the unseen event handler 206 resorts to the external environment, essentially because the external environment cannot provide inheritable model parameters since KPI values may be different. If at block 430, no similar previously seen IT alert is found, then the unseen event handler 206 outputs error 436.

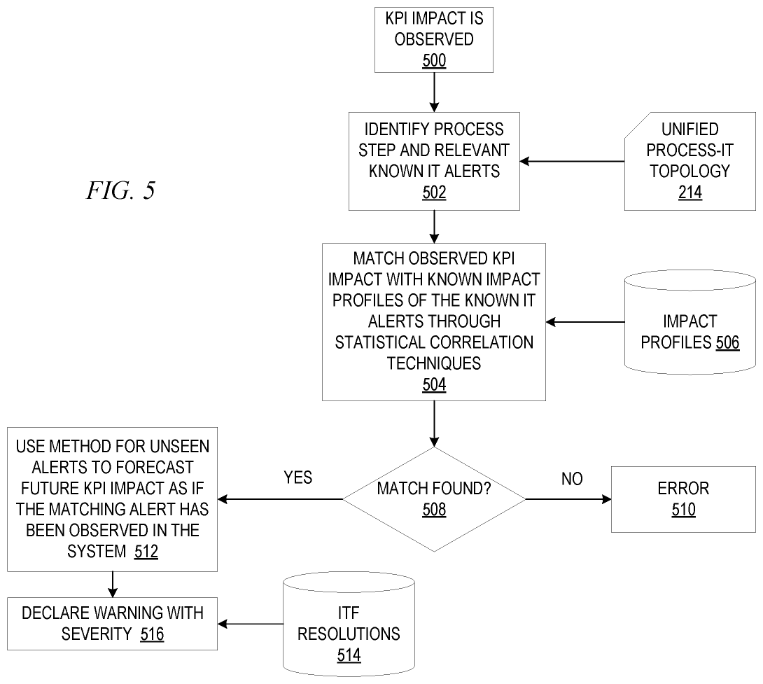

FIG. 5 is an example diagram that illustrates an example of operations performed by the unseen event handler 206 and the impact profile matching engine 208 in response to the computer-generated indication 220 corresponding to a KPI impact, in accordance with one or more illustrative embodiments. The KPI impact is an adverse change in a KPI (e.g., a reduction in the value of the KPI by a predetermined or threshold amount) of a process. Accordingly, a KPI impact indicates a deterioration in execution of the process. The KPI impact can imply or indirectly indicate an ITF even though there is no observable indication of the ITF itself. The unseen ITF detector 204, nonetheless, can discern an otherwise unobservable ITF by detecting the KPI impact. For example, unseen ITF detector 204 may identify a sharp drop (e.g., greater than 20 percent decline) in a KPI that measures the percentage of online payments received by an organization as an indication that an invoice management application has failed even though the IT system has not generated an IT alert. ITF impact prediction framework 200 provides an accumulation of information for a wide range of IT alerts and failures from a variety of sources. Unified OP-IT topology 214 aligns and links the different IT alerts and failures to the steps of one or more processes (e.g., real-world organization processes) and their KPI impact profiles. A KPI impact profile of an IT alert can indicate which KPIs are impacted by the IT alert (e.g., daily sales volume), quantify the impact (e.g., the percentage drop in sales), indicate a severity of the KPI impact (e.g., low, medium, high), and specify the duration of impact (e.g., how long the period of low sales lasted before re-attaining normal levels).

In response to a KPI impact, the impact profile matching engine 208 operates to detect a match between an impact profile of the KPI impacted and a known IT alert. The match by the impact profile matching engine 208 can be based on statistical correlation between the KPI impacted and parameters of the impact profile of each of a plurality of known IT alerts.

In block 500 of the example of FIG. 5, the unseen ITF detector 204 observes a KPI impact. Based on the unified OP-IT topology 214, the impact profile matching engine 208 in block 502 identifies one or more relevant IT alerts with a process step whose performance is measured by the KPI whose impact is observed. The impact profile matching engine 208, in block 504, matches the observed KPI impact with impact profiles of known IT alerts by searching a database of impact profiles 506. The identification by the impact profile matching engine 208 can be made using statistical correlations techniques that assess the strength of association between the KPI and parameters of the IT alerts. If, in block 508, no statistical correlation greater than a predetermined threshold (e.g., 85 percent confidence) is detected, then the impact profile matching engine 208 outputs error 510.

If, in block 508, the impact profile matching engine 208 determines a match, then the operations of the unseen event handler 206 are automatically invoked in block 512. In block 512, the unseen event handler operates as though the KPI impact were a previously unseen ITF. Thus, once a matching known IT alert is identified by the impact profile matching engine 208, the unseen event handler 206 can perform the above-described operations (FIGS. 2-4) to generate the ITF impact prediction and recommendation 222, albeit in response to, and based on, the observed KPI impact. The event handler 206, in certain illustrative embodiments, retrieves from a database of the ITF resolutions 514, certain recommendations and/or actions used previously in response to an ITF corresponding to the IT alert matched to the observed KPI impact. The ITF resolutions 514 can comprise resolution history 516 for resolving the matched IT alert. The resolution history 516 can include an RCA and other insights, which can be used to apply IT SRE techniques for rapidly and accurately resolving the ITF that caused the observed KPI impact. The ITF would otherwise have been unobserved. By identifying the ITF in response to, and based on the KPI impact, the effect of the ITF can be alleviated or mitigated. In the context of organization processes, for example, this rapid and effective resolution can avoid or lessen losses in organization service availability and/or revenues.

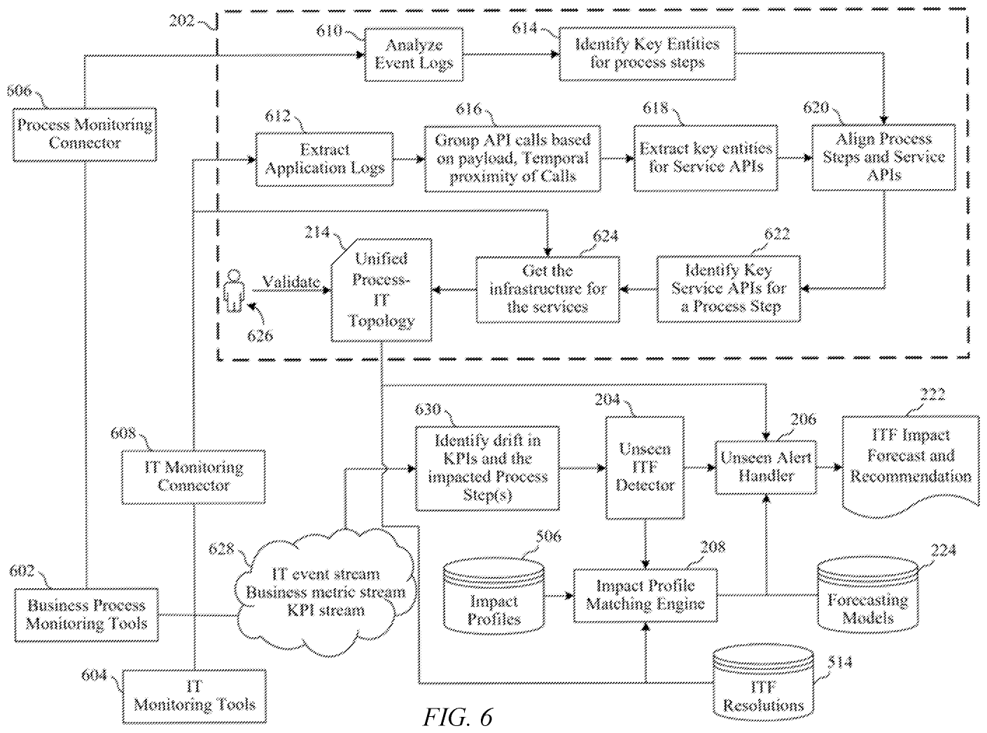

FIG. 6 is an example diagram that illustrates an example of the unified OP-IT topology generation as performed by the unified topology generator 202 of example architecture 200 in accordance with one or more illustrative embodiments. In the example of FIG. 6, the unified topology generator 202 generates a unified OP-IT topology 214 with respect to an organization process performed by an organization and supported by an IT infrastructure of the organization (see FIG. 7). Illustratively, the unified topology generator 202 communicatively couples, via a wired or wireless connection, to organization process monitoring tools 602 and IT monitoring tools 604, though the process monitoring connector 606 and the IT monitoring connector 608, respectively.

Referring additionally to FIG. 7, the unified OP-IT topology 214 is generated by the unified topology generator 202 with respect to the example process IT combination 700. The process IT combination 700 can model one or more real-life process, including various organization processes. The process IT combination 700 illustratively includes modeled process 702. The modeled process 702 is supported by IT applications and services 704. The IT applications and services 704 illustratively include the order management application 706, the inventory app 708, and the invoice management app 710, each of which performs multiple services. The IT applications and services 704 execute on the IT infrastructure and platforms 712.

Referring still to FIG. 6, in block 610, the unified topology generator 202 analyzes event logs generated by the organization process monitoring tools 602. The unified topology generator 202, in block 612, extracts application logs generated by the IT monitoring tools 604. The actions in blocks 610 and 612 can be performed by the unified topology generator 202 concurrently or at different times during the generative process.

In block 614, the unified topology generator 202 identifies key entities of process steps, the key entities uniquely identifying one or more properties of each service, and whose values identify each service's type at run time. For a process step describing an activity, such as creating an order, for example, the key entity includes the words “create order” and the attribute values associated with this entity, recorded in the process log. Attributes correspond to the activity details, including a timestamp. For an API call (e.g., /api/v1/create_order), the key entity would be the phrase “create_order” and the payload will contain the order details including the timestamp. As such, the key entities for service APIs are usually embedded within the function calls themselves, whereas the key entity for a process step, as recorded in the process logs, is usually found in the activity name column.

In block 616, the unified topology generator 202 groups API calls from the extracted application logs based on temporal and/or semantic proximity to one another, as indicated from the API calls' payloads and temporal proximity to one another. In block 618, the unified topology generator 202 extracts key entities for service APIs.

In block 620, the unified topology generator 202, as described in the following paragraphs, aligns the process steps-place, validate, prepare, and ship order, followed by payment receipt—of the modeled process 702 and the service APIs of IT applications 704, 706, 708, and 710. In certain illustrative embodiments, the aligning is based on a mapping generated using the Hierarchical Dirichlet Gaussian Marked Hawkes Process, described below. However, it should be appreciated that this is only an example and other embodiments may utilize other methodologies and computer processes for generating such a mapping without departing from the spirit and scope of the present invention.

After identifying key service APIs for each process step in block 622, the unified topology generator 202 retrieves the infrastructure for services in block 624. Having aligned and linked the process steps of modeled process 702 with the IT events, the unified topology generator 202 generates unified OP-IT topology 214.

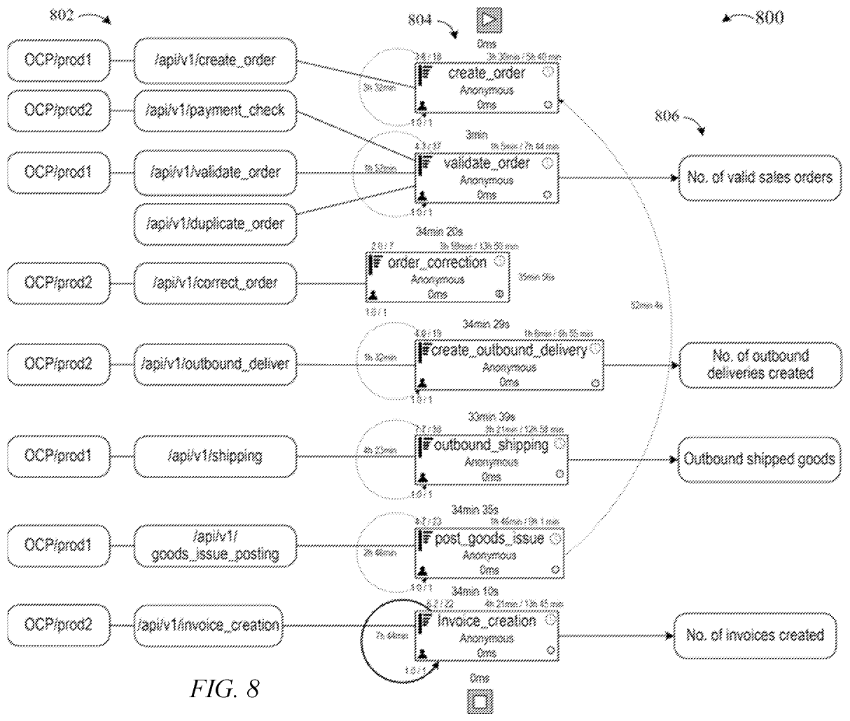

Referring additionally to FIG. 8, a portion 800 of the unified process-IT topology 214 is illustrated in which IT system elements 802 are linked to process steps 804 in accordance with one or more illustrative embodiments. Important KPIs 806, corresponding to organization steps, can be identified and linked to the IT system elements 802, which include API calls, for example. Optionally, the identification can be through a post-hoc validation by user 626.

In certain illustrative embodiments, the unified OP-IT topology 214 introduced herein implements a Hierarchical Dirichlet Gaussian Marked Hawkes Process (HD-GMHP). The HD-GMHP implemented by the unified process-IT topology, as introduced herein, models the triggering relationship between events, thereby identifying which preceding events trigger an occurrence of a current event. Thus, in the context of a process (e.g., organization process), the HD-GMHP can model an event sequence in which a process step depends on one or more preceding steps. Using meta-information of events, such as location and keywords structured as feature vectors, the illustrative embodiments can identify both IT and process events through event embedding techniques from the domain of process mining (e.g., process/suffix prediction). Using temporal characteristics in an event stream, the illustrative embodiments can predict a likely process event based on a close temporal proximity of one or more related process events.

The illustrative embodiments can use the HD-GMHP for local clustering with respect to each event stream. This allows events in multiple local clusters from separate streams, which may be characterized by large time differences, to be represented in a single global cluster through a Hierarchical Dirichlet Process (HDP) that links each Gaussian Marked Hawkes Process (GMHP).

The process steps and IT events are two concurrent event streams. Aligning and linking process steps and API calls involves the above-described grouping of both. In one or more embodiments, the unified topology generator 202 ensures a one-to-one correspondence between distinct groupings, or clusters, of process steps and IT events (e.g., API calls) by suitably modifying the sequential Monte Carlo sampling procedure of the HD-GMHP. The HD-GMHP, as implemented by the unified topology generator 202, generates a single global cluster by only sampling events from two local clusters that are each from different event streams—an event stream of process steps and a stream of IT events (e.g., API calls). As implemented, the HD-GMHP does not assign a third cluster from either stream to the global cluster. In general, event embedding spaces are necessarily different for process steps and IT events (due to different terminologies). While this does not necessarily hinder the unified topology generator 202's sampling of local clusters in each individual event stream (since each can be treated as a separate GMHP), it can be problematic for sampling the global clusters. The problem is solved in two different embodiments of the unified topology generator 202.

In one embodiment, the unified topology generator 202 prevents a flow of embedding information between local clusters in different streams and restricts sampling such that only the embedding information within the same stream is eligible. Nevertheless, the unified topology generator 202 shares temporal information across the local clusters in different event streams during the sampling process. In the other, more complex embodiment, the unified topology generator 202 uses a probabilistic model, or deep learning neural network, that links the two embedding spaces by learning a probabilistic mapping function that takes an embedding from one space as input and generates a probability distribution over embeddings in the other space as output. The unified topology generator 202 uses this mapping during the cluster sampling process for linking and aligning similar process steps and IT events.

Referring still to FIG. 6, with the creation of the unified OP-IT topology 214 by unified topology generator 202, an IT event stream, organization metric steam, KPI stream, and/or other data stream received via communications network 628 can be processed by the unseen ITF detector 204, the unseen event handler 206, and impact profile matching engine 208 according to the procedures described above in connection with FIGS. 2-5. To maintain the accuracy of the ITF impact predictions and the recommendations generated over time, drift identifier 210 in block 630 can identify KPI drift that can occur over time and can determine the impact with respect to any process step(s) whose performance is measured by an affected KPI. Based on the determination, unified OP-IT topology 214 can be updated or revised by unified topology generator 202 in response to detected KPI drift.

For example, an organization that uses the modeled process 702 for placement, validation, preparation, and shipment of customer orders, may measure the percentage of payment receipts handled electronically by invoice management app 710. If over time a greater percentage of payments are handled online, a corresponding KPI measuring the percentage increases commensurately. The change (KPI impact) can affect, for example, operation of the unseen ITF detector 204. The ITF detector 204 can detect a possible ITF that is otherwise unobserved by noting a greater-than-threshold event in a corresponding KPI (see FIG. 5). If the desired value of the KPI that measures the percentage of payments handled online by invoice management app 710 is not revised upward due to drift (increase in payments processed electronically), then a drop in the KPI due to a failure of invoice management app 710 may not be detected. A drop in the KPI relative to the pre-drift value may not be greater than the predetermined threshold (e.g., 20 percent drop). If the KPI has been revised upward to reflect the drift, a drop in the KPI relative to the now-higher value is more likely greater than the threshold and is thus, recognized by the unseen ITF detector 204 as an indication of a possible ITF. Detecting the KPI impact (e.g., drop in percentage of payments processed electronically) invokes the operations of the other ITF impact prediction framework 200 elements, as already described above.

### Resource Allocation Based on Remediation Action Recommendations

In some illustrative embodiments, causal models are built to predict the impact of events on organizational processes and KPIs. The unified model of OP-IT topology may be used with the causal models to determine where to allocate resources in accordance with a remediation action to maximize benefits to KPIs and organizational processes with minimum resource allocation costs.

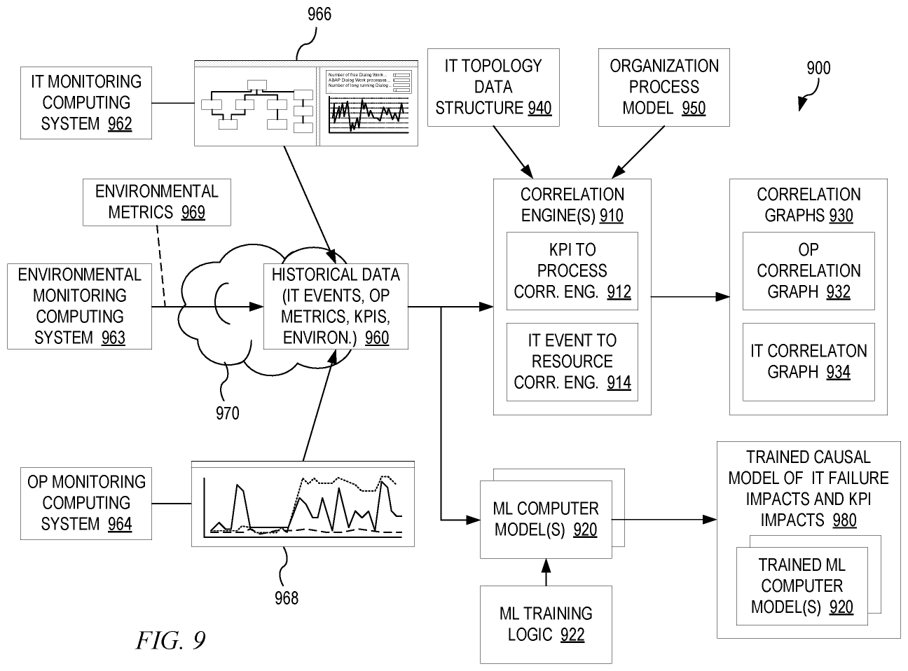

FIG. 9 is an example block diagram illustrating the primary operational components of an organizational performance (OP) and information technology (IT) correlation-based forecasting computer tool, referred to hereafter as the OP-IT forecasting computing system, during offline machine learning training in accordance with one illustrative embodiment, which trains one or more causal models. It should be appreciated that the “offline” machine learning training is performed on historical operational performance (OP) and event data prior to online operation, where the OP-IT forecasting computer tool or computer system operates on runtime collected events, OP metrics, and key performance indicators (KPIs), such as may be collected by OP operations monitoring computing tools, IT performance and IT event monitoring computer tools, event data sources, such as weather and social networking website sources, or the like. While an offline machine learning training is depicted in FIG. 9, it should be appreciated that in some illustrative embodiments, this training may be updated at later times based on recorded OP and event data so as to update the training of the machine learning computer model(s) based on observed events, to potentially learn new correlations between OP and events, KPIs of OP operations and events, and the like, and thereby train one or more machine learning causal models.

It should be appreciated that, for ease of explanation herein, the events will be considered to be IT related events, i.e., events that occur within the IT infrastructure, e.g., power failures, device failures, bandwidth usage increases/decreases, processor/storage usage increases/decreases, etc. However, the illustrative embodiments may also operate on non-IT events, either in addition to, or in replacement of, IT events. Non-IT events may be any event, not directed attributed to IT infrastructure components, which affects organizational processes and KPIs. Examples of such events may include environmental events, e.g., weather related events, wildfire events, disease outbreaks, etc., governmental and organizational policy related events (e.g., governmental shutdowns, organizational changes), workforce events (e.g., strikes or the like), and the like. Any IT events and/or non-IT events for which there is historical data that can be used to train a machine learning model may be an “event” in the context of the present application. For purposes of illustration, the following description will focus on IT related events, but this is intended to be non-limiting to IT related events.

As shown in FIG. 9, the OP-IT forecasting computing system or computer tool 900 comprises an OP-IT correlation engine 910 and one or more machine learning computer model(s) 920. The OP-IT correlation engine 910 and the one or more machine learning (ML) computer models 920 are trained based on historical data 960, which may comprise event data, e.g., IT event data (although as mentioned above, in some embodiments may include non-IT event data), and OP event data, where the OP event data may comprise metrics which are then used to generate key performance indicators (KPIs) for the OP operations, systems, and the like. In addition, in some illustrative embodiments, the historical data 960 may comprise environmental metrics, such as weather, temperature, humidity, power, personnel measures, and other metrics characterizing an operational environment of the IT computing resources and OP operations, e.g., weather may impact shipping operations of an organization and thus, various weather metrics may be impactful of KPIs and IT events.

The historical data 960 may be compiled and collected by various historical data source computing systems 962-964. For example, the historical data source computing systems 962-964 may comprise one or more IT monitoring and event alert generation computing systems 962 that monitor IT computing resources by measuring and collecting metrics, e.g., processor usage, storage usage, memory usage, network bandwidth, etc., and generates IT events, incidents, and/or alerts 966 based on the measured and collected IT metrics data. For example, if available storage space falls below a predefined threshold, an IT event and/or alert may be generated indicating “low storage availability” or the like. There are monitoring tools such as IBM Instana™ that collect the IT metrics data and can generate IT events based on user-defined policies of storage space or other IT resources. For non-IT events, other data collection sources may provide event data, such as weather data, social network based data, e.g., reports on strikes, governmental regulations, organizational policy changes, and the like.

The historical data source computing systems 962-964 may further include one or more organizational performance (OP) monitoring computer systems 964 that monitor key performance indicators (KPIs) for organizational level operations, where these KPIs may be based on raw metric data collected and used to calculate higher level KPIs according to predefined KPI definitions. For example, KPIs that may be used to monitor the health and performance of an organization may be of the type including number of orders processed within a given time period, number of orders delivered within a given time period, weekly average order cycle time, daily order processed amount, weekly order re-work rate, and the like. The OP monitoring computer systems 964 may report KPI data 968 for various organizational processes.

One example of an OP monitoring computer system 964 that may operate and provide a portion of the historical data 960 may be the IBM Process Mining™ computer tool available from International Organization Machines (IBM) Corporation of Armonk, New York. IBM Process Mining™ is a process mining solution that automatically discovers, constantly monitors, and continuously optimizes the organizational processes. Process mining uses organizational system data to create and visualize an end-to-end process that includes all process activities involved along with various process paths. Other examples of OP monitoring computer systems 964 that may be utilized may include Organization Process Operations (BPO) dashboards in System Analysis Program (SAP), available from SAP SE of Weinheim, Germany, or the like.

Another historical data source computing system 962-964 that may provide a portion of the historical data 960 may comprise one or more environmental monitoring computing systems 963 that monitor the various environments that may affect the organization's performance and/or IT computing resource operations. These environmental monitoring computer systems 963 may monitor computing environments of the IT computing resources, such as internal temperatures, power availability, and the like, of facilities in which the IT computing resources are located. These environmental monitoring computer systems 963 may also comprise external weather conditions, such as temperatures, precipitation, storm situations, power outages, and the like, which may be obtained from other weather reporting organizations and agencies, e.g., the national weather service (NWS) of the United States of America, or the like, through data feeds and the like. In some cases, the environmental monitoring computer systems 963 may comprise reporting systems that report on social issues, such as personnel issues, e.g., strikes, disease, etc., and governmental/organizational regulations/policies, such as government lockdowns, border closures, and the like. The environmental conditions data 969 generated by the environmental monitoring computer systems 963 may specify various metrics and corresponding temporal characteristics, e.g., timestamps, of when these metrics were measured as well as other information specifying locations where these metrics were measured and the like.

It should be appreciated that while these historical data source computing systems 962-964 are shown and described herein as examples, other historical data sources may provide other portions of historical data 960 in addition to, or in replacement of, portions of historical data provided by these historical data source computing systems 962-964. For example, social networking computer systems that may report notable events, news feed computing systems, transportation network monitoring computing systems, and the like, or any other suitable computing systems that monitor and report data representing conditions that may impact or influence organization performance operations, such as may be measured by predefined KPIs, and/or IT computing resource performance, such as may be measured by IT metrics, may operate as historical data sources providing portions of the historical data 960. For example, news feeds may provide data indicating power outages, weather events, political and/or social events that may impact operations, traffic conditions, and the like. Transportation network monitoring computing systems may report data indicating transportation pathway slowdowns, shutdowns, and the like, congestion at ports, and the like, which may all impact organization performance and corresponding KPIs.

It should be noted that, in accordance with one or more illustrative embodiments, the historical data 960 comprises IT and OP events, corresponding IT metrics, OP KPIs, and the like, that have corresponding temporal characteristic data such that cause-and-effect relationships may be evaluated and identified in the IT and OP events, IT metrics, and KPIs. That is, over a period of time, the correlation engine 910 may evaluate the historical data and generate correlation graphs 930 that correlate IT and OP events, IT metrics, and KPIs based on the temporal characteristics. For example, IT metrics may indicate an IT alert or event situation in which there is low processor availability during a particular temporal period, during that particular temporal period, there were certain batch job error rate alerts generated, and that at approximately a same time, one or more KPIs were below a given threshold, e.g., number of orders processed was below a predetermined threshold. Correlations between these historical data 960 may be determined by the correlation engine 910 to generate correlation graph data structures 930 for various ones, or combinations of, these portions of historical data 960.

The correlation engine 910 uses the historical data 960, such as event logs, metrics, KPIs, and the like, that are recorded in the historical data along with their corresponding temporal characteristics, and correlates this information with IT topology data structures 940 specifying the IT topology of the organization's IT infrastructure, and process model data structures 950 that specify the organization and hierarchy of organizational processes across the organization. To generate the KPI to process step correlation, the historical data of KPIs and OP metrics corresponding to different process steps are processed as time series data. Different statistical casual models used on this time series data to identify the causal relationship between the OP metrics corresponding to the process step and the KPIs. A similar approach of correlating the environmental event data with KPIs is used where casual models are applied to identify the relationship between the environmental factors and KPIs. For the IT metrics, the IT topology is used that provides information about the various IT metrics and errors associated with each IT resource. Hence, a causal relationship is derived between the IT errors and IT metrics with the resource based on the IT topology.

For example, the historical data 960 may be parsed and analyzed to identify instances of indicators in the logged events, indicators of processes corresponding to IT metrics and/or KPIs, and the like, that are indicative of particular IT topology elements and/or organizational processes that were involved in or otherwise affected the historical data 960 recorded events, incidents, alerts, etc., and the corresponding metrics, KPIs, and the like. These indicators may be correlated by the correlation engine 910 with IT computer resource indicators in the IT topology data structure 940 and organizational process indicators in the process model 950. In one illustrative embodiment, as depicted in FIG. 9, the correlation engine 910 comprises a first correlation engine 912 that correlates KPIs with organizational processes based on these input data structures 940-960, and a second correlation engine 914 that correlates IT events with underlying IT computing resources based on these input data structures 940-960. These correlation engines 912-914 may generate corresponding correlation graph data structures 930, and may combine correlations into one or more multi-dimensional correlation graph data structures in 930 that correlate KPIs with organization processes, with IT events, and IT computing resources.

The IT topology data structures 940 specify the IT computing resources, which may be hardware and/or software computing resources, their dependencies and relationships. The process model data structures 950 specify the organization processes, which are higher level processes representing operations and functions performed by portions of the organization at an organization level rather than the underlying IT computing resource level. For example, the IT topology data structures 940 may specify that one computing device communicates with another computing device, whereas the process model data structures 950 may specify that a process for creating an order has a dependent process hierarchy comprising a dependent process of validating the order, which has a dependent process for creating an outbound delivery, etc. The IT Topology data structure 940 can be discovered from IT monitoring tools such as IBM Instana™. Similarly, the Organization Process model 950 can be discovered from monitoring tools such as IBM Process Mining™ tool.

The historical data 960 is also input to train one or more machine learning (ML) computer models 920 to train these ML computer models 920 to perform prediction/forecasting of IT events given input KPIs, KPIs given IT events, and the like (again, while IT events are mentioned here, such events may also comprise non-IT events). For example, the IT events, and their corresponding characteristics or features, occurring within a given period of time may be input to a first ML computer model, i.e., an IT to KPI forecasting ML computer model 920, which then predicts/forecasts KPIs for the period of time given the input IT event characteristic/feature data. These predications/forecasts may be compared against the actual KPIs recorded in the historical data 960, which operate as a ground truth for the machine learning training. The differences between the predictions/forecasts and the actual recorded KPIs may be used to calculate a loss for the machine learning computer model, or an error. ML training logic 922 may be used to modify operational parameters of the ML computer model so as to reduce this loss, or error. For example, a stochastic-gradient-descent (SGD) based machine learning training, or other known or later developed machine learning training algorithm, may be used to modify the operational parameters of the machine learning computer model so as to reduce the loss/error. This process, which may be implemented as supervised or unsupervised machine learning operations, may be repeated for a predetermined number of iterations, or epochs, or until the loss satisfies a predetermine criteria, e.g., loss below a predetermined threshold.

In this way, the ML computer model 920 learns correlations between input patterns of IT event characteristics/features and corresponding KPIs. The input features that are input to the ML computer model 920 may, in some illustrative embodiments, include IT alert values, IT metrics values, relevant OP metrics, the time of the day, the day of the week, and various other such features, for example. Thus, after machine learning training is complete, the trained IT to KPI forecasting ML computer model 920 is able to predict or forecast, given a set of IT event characteristic data, the KPIs that may result within a given period of time.

A similar machine learning training may be performed with regard to a second ML computer model 920 that learns patterns of input KPIs and their characteristics/features, and IT events, incidents, or alerts. The second ML computer model 920, referred to as a KPI to IT forecasting ML computer model 920, may then, after having been trained through machine learning training by the machine learning training logic 922, predict/forecast IT events that are likely to occur given an input set of KPIs and/or KPI characteristics/features. Thus, with the ML computer models 920, the mechanisms of the illustrative embodiments are able to predict/forecast IT events and KPIs based on learned relationships between IT events with their characteristics/features, and KPIs with their characteristics/features.

With the machine learning training of the ML computer models 920, and the generation of the correlation graph data structures 930, these mechanisms may be applied to runtime data to predict/forecast IT events/KPIs and correlate these with IT computing resources and organizational processes that are affected by the predicted/forecasted IT events/KPIs. That is, the predictions/forecasts output by the ML computer models 920 may be used with the correlation graph data structures 930 to identify specific OP operations and IT computing resources impacted by the IT events or KPIs. For example, a first correlation graph data structure 932, referred to as the OP correlation graph 932, may be used to correlate different organizational, or OP, operations with corresponding KPIs. Thus, given a prediction/forecast of KPIs, corresponding OP operations affected by the predicted/forecasted KPIs may be identified. A second correlation graph data structure 934, referred to as the IT correlation graph 934, correlates an IT topology 940, i.e., the various IT computing resources, with corresponding IT events. Thus, given a prediction/forecast of IT events (and/or non-IT events in some illustrative embodiments), corresponding IT computing resources affected by the predicted/forecasted IT events may be identified. The prediction/forecast of IT/non-IT events may be generated based on the unified model of OP-IT topology previously discussed above, for example.

Thus, based on the correlations learned based on the historical data 960 used to train the ML computer model(s) 920, the trained ML computer model(s) 920 may forecast IT events based on given KPIs or changes to KPIs, and can forecast KPIs, or changes to KPIs, based on the occurrence of IT events. In addition, as will be described hereafter with regard to runtime online operation, machine learning computer models 920 may be used to generate predictions based on counterfactual analysis, i.e., exploring outcomes that have not actually occurred, but could have occurred under different conditions. This counterfactual analysis is done by changing the input to the model 920 and then predicting the output. Here, for example, the input to the ML computer model(s) 920 may be manipulated to reflect the IT metrics coming back to normalcy (or below the thresholds) and then forecast the KPIs. The OP metrics data may also be changed, for example, change the pending orders to a low value, and the ML computer model(s) 920 may be used to predict the impact on the IT metrics.

In one or more illustrative embodiments, logic may be provided that generates alternative scenarios based on the predictions/forecasts generated by the ML computer model(s) 920 by extrapolating or projecting the predicted/forecasted conditions, e.g., KPIs, IT events, etc., for a period of time in the future. For example, a linear regression based projection may be used to assume that, if nothing is changed, i.e., no remediation actions are performed, then the predicted/forecasted conditions will continue along a linear projection into future time points. As discussed hereafter, this may be compared to predictions/forecasts should remedial actions be implemented to address the predicted/forecasted IT events, KPIs, etc. so as to determine the impact of remedial actions on KPIs and IT events, which may be used as a factor in ranking remedial action recommendations, for example. In this way, the ML computer models 920 may be used to simulate conditions for counterfactual analysis and evaluation of remedial action recommendations.

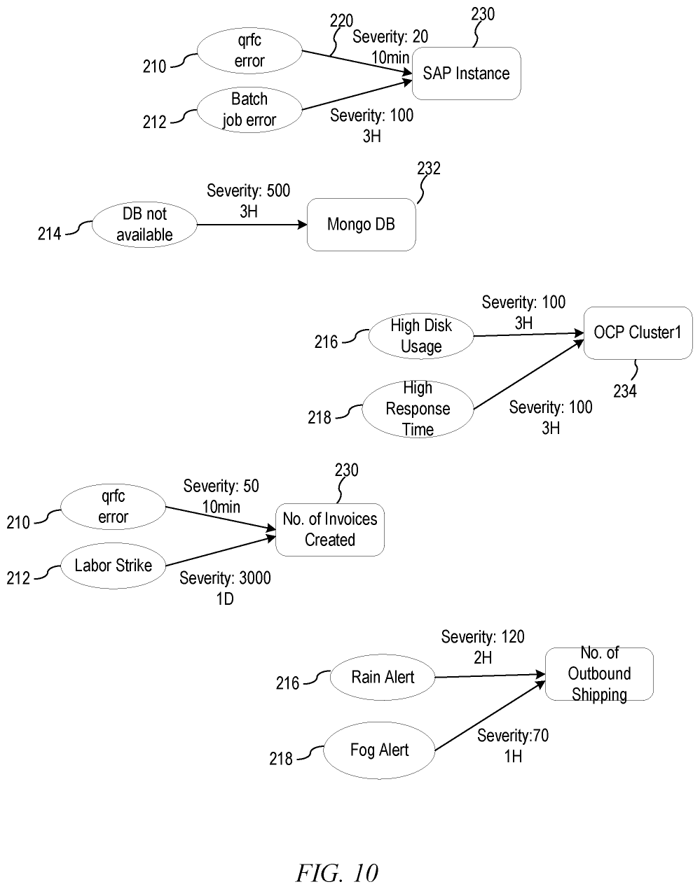

As noted previously, the predictions/forecasts generated by the ML computer models 920 are used as a basis for performing correlations by applying the correlation graph data structures 930 to the predictions/forecasts. In this way, the affected IT computing resources and/or organizational processes may be identified given the predicted/forecasted IT event/KPI conditions. FIG. 10 is an example diagram illustrating an example IT correlation graph in accordance with one illustrative embodiment. As shown in FIG. 10, the IT correlation graph 1000, which may be represented as elements of an IT correlation graph data structure 934 in FIG. 9, for example, comprises nodes 1010-1018 corresponding to IT events, incidents, or alerts that are logged or otherwise represented in the historical data 960, and edges 1020 connecting these IT events to corresponding nodes 1030-1034 representing IT computing resources. This graph uses the IT topology data 940 to identify the IT nodes that are associated to the IT events. A monitoring tool that captures the IT metrics also contains the information about the IT node where the alert is occurring. The information from the monitoring tool is used to create this IT topology data structure 940. However, in some cases, there can be transitive dependencies. For example, a high disk usage, can cause a database to not be available. Such relationships are captured by using the historical time series data of different IT metrics and capturing a causal relationship between IT metrics. The IT correlation graph 1000 may be generated by the correlation engine 914 that maps indicators of IT events with IT computing resources specified in the IT topology 940 based on indicators in the logs and other historical data 960 specifying locations of the IT events, temporal characteristics, and the like.

Thus, for example, the depicted IT correlation graph 1000 correlates IT events, incidents, or alerts, of “high disk usage” (node 1016) and “high response time” (node 1018) with the IT computing resource OpenShift Container Platform (OCP) cluster 1 (node 1034). Similarly, nodes 1010-1012 are mapped to the SAP instance represented by node 1030 and node 1014 is mapped to Mongo Database (DB) represented by node 1032.

The IT correlation graph 1000 maps each IT event and its characteristics to one or more corresponding IT computing resources. Thus, when new data is received representing IT events, such as predictions/forecasts generated by the trained ML computer models 920 of the illustrative embodiments, then these IT events may be matched to one or more matching nodes 1010-1018 and a measurement of correlation may be generated. Thus, for example, various characteristics of the predicted/forecasted IT event may be compared to characteristics of mapped IT events, e.g., an IT event may involve multiple error conditions, IT resource conditions, or the like, which may be characteristics used to compare to the IT correlation graph 1000, to thereby generate a measure of correlation and identify the most likely portions of the IT correlation graph 1000 that match the predicted/forecasted IT event(s). This will identify which IT computing resources are most likely to be affected by the IT event.

It should be appreciated that similar correlation graphs may be generated for IT and non-IT events, also referred to as environmental events, and organizational processes (OPs)/IT resources. Examples of such non-IT events include weather conditions, governmental/organizational regulations/policies or actions, personnel events, such as strikes, health related events, e.g., pandemics, disease outbreaks, and the like. For example, nodes 1042-1048 may be associated with corresponding operational processes 1052-1058 demonstrating a relationship between such non-IT, or environmental, events and operational processes, e.g., rain/fog affects shipping.

Similar operations may be performed with regard to the organizational process correlation graph, but with some modifications due to the different way in which the organizational process correlation graph represents organizational processes. Referring again to FIG. 8, which may be considered an example diagram illustrating an example organizational process correlation graph in accordance with one illustrative embodiment, this graph can be represented by a data structure, such as organizational process correlation graph data structure 932 in FIG. 9. As shown in FIG. 8, elements of the organizational process correlation graph include nodes representing sub-processes of an overall process, where there may be a separate organizational process correlation graph for each overall process that the organization monitors. Edges between the nodes represent the dependencies, calling capabilities, and/or data communication pathways between sub-processes, e.g., the sub-process “post_goods_issue” may return data to the sub-process “create_order” as indicated by the edge between these nodes.

Edges may also exist from a node to itself to thereby represent execution time of the corresponding sub-process. For example, an edge goes from the node “create_order” back to itself representing that the “create_order” sub-process takes 3 hours and 32 minutes. The nodes and edges have corresponding characteristics or features including temporal characteristics specifying the amount of time that the process requires to perform an associated operation. The combination of nodes and edges represents an end-to-end organizational process with all its sub-processes, their dependencies and communication pathways, and temporal characteristics.

As shown in FIG. 8, in addition to the nodes and edges, the nodes are also provided that represent the various KPIs, where these nodes are linked through corresponding edges to the particular sub-processes with which the KPIs are associated. For example, a node may be provided that represents a KPI of “No. of valid sales orders” which is associated with the sub-process “validate_order”. Similarly, the KPI “No of outbound deliveries created” is associated with the sub-process “create_outbound_delivery”. As another example, the KPI “Net order value” is associated with the sub-process “invoice_creation”.

Thus, the organizational process correlation graph shown in FIG. 8 correlates KPIs with corresponding processes and sub-processes. Hence, given a predicated/forecasted KPI, the processes and sub-processes that will be affected by the predicated/forecasted KPI may be identified through the mapping and correlation provided by the organizational process correlation graph of FIG. 8, e.g., a predicted/forecasted change to a KPI in FIG. 8 shows that the linked process is affected or may in some way be involved in the change to the KPI, as well as specific linked sub-processes. For example, if the number of outbound deliveries is predicted/forecasted to drop, then it can be determined that the create_outbound_delivery sub-process of the process may be affected or may be a cause of this drop. To generate such a causal model, the OP metrics that are associated to each process step (for example the number of outbound shipping events is associated to the process step outbound_shipping) are obtained. Then, various observations may be made in the time series data, such as if it is observed that there is a high correlation between the OP metrics corresponding to the process step and the KPI “outbound shipped goods,” a causal relationship can be generated between the KPI and the process step. There could be many false positive relationships that can be discovered. Hence, additional causality detection algorithms are used where the time series data from the OP metrics and KPI are used to discover casual relationships.

Thus, through the training of the OP-IT forecasting computing system or computer tool 900 based on the historical data 960, IT topology 940, and process model 950, correlation graph data structures 930 and one or more ML computer models 920 are automatically generated to predict/forecast IT events, KPIs, and changes in KPIs, as well as correlate these predictions/forecasts with the particular organizational processes and sub-processes and IT computing resources that are affected by or otherwise are involved in the predicted/forecasted conditions, e.g., IT events, KPIs, or changes in KPIs. In particular, the correlation engines 912 and 914 operate on the historical data 960 and the IT topology 940 and process model 950 to generate the correlation graph data structures 930 mapping IT events to IT computing resources and KPIs to particular organizational processes and sub-processes (collectively referred to as processes in general). Moreover, machine learning training logic is applied to ML computer models 920 to train the one or more ML computer models 920 on the historical data 960, operating as training data and ground truth data, to identify patterns in input data and generate predictions/forecasts regarding the impact of the input data with regard to IT events and KPIs. Having trained these components of the OP-IT forecasting computing system or computer tool 900, the OP-IT forecasting computing system or computer tool 900 may be deployed for runtime, or online, operation based on newly collected data from source computing systems, e.g., 962-964, monitoring the various IT computing resources, environmental conditions, and organizational processes.

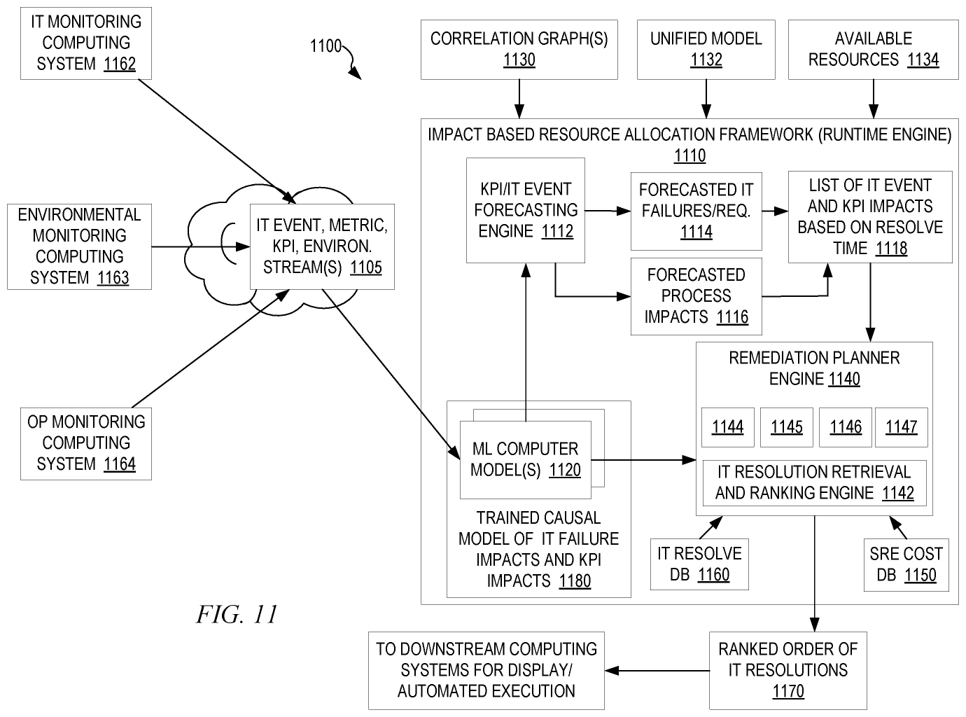

FIG. 11 is an example block diagram illustrating the primary operational components of an OP-IT forecasting and resource allocation computing system (hereafter referred to as the “system”) during online operations in accordance with one illustrative embodiment. It should be appreciated that the system 1100 in FIG. 11 assumes a training of ML computer models and generation of correlation graph data structures in accordance with one or more of the illustrative embodiments, such as described previously with regard to FIGS. 9-10. Thus, the trained ML computer models 1120 may be the ML computer models 920 in FIG. 9, for example, which have been trained on the historical data 960. Similarly, the correlation graphs 1130 may be the correlation graphs 930 in FIG. 9 generated by the correlation engine 920 based on the historical data 960, the IT topology 940, and the process model 950.

In addition, the system 1100 in FIG. 11 also assumes a generation of a unified model 1132 of OP-IT topology, such as previously described in regard to FIGS. 2-8. Thus, the runtime engine 1110 receives as inputs, the event streams 1105, correlation graph data structures 1130, unified model 1132, and in addition may receive data structures indicating currently available resources 1134, where these resources may be IT resources, human resources, or the like. The currently available resources 1134 data structures may be provided by organization and IT infrastructure monitoring computing systems, e.g., a Configuration Management Database (CMDB), an Enterprise Resource Planning (ERP) system, such as Systems Applications and Products (SAP), for retrieving currently available organization resources, and/or the like, which track allocation of resources to different parts of the organization and/or IT infrastructure. From these inputs, the runtime engine 1110 predicts the impact of events, e.g., IT and non-IT events, on operational processes and KPIs, and correlates these impacts with IT infrastructure. Based on the predicted impact, the runtime engine 1110 may determine candidate remedial actions and their corresponding resource allocations and rank them based on predicted beneficial effect on KPIs versus resource allocation costs, so as to present an appropriate ranked listing of remediation actions, resource allocations, and costs to appropriate personnel, and/or select a remedial action for implementation.

As shown in FIG. 11, a runtime engine 1110 of the system 1100 receives, as input data, IT event streams, organizational metric/KPI streams, and environmental metrics streams 1105. These streams of data may be received from various source computing systems, such as IT monitoring computing system 962, environmental monitoring computing system 963, and/or organizational performance (OP) monitoring computing system 964 in FIG. 9, for example. These streams of data are input to the trained ML computer models 1120 and the runtime engine 1110. The runtime engine 1110 comprises a KPI/IT event forecasting engine 1112 comprising logic to take the predications/forecasts generated by the ML computer models 1120 based on the input streams 1105 and correlate these predications/forecasts with IT computing resources and/or organizational processes and sub-processes using the correlation graph data structures 1130 and unified model 1132. That is, the KPI/IT event forecasting engine 1110 identifies the impacted organizational operations and IT computing resources based on the mapping of KPIs to organizational processes and sub-processes, and the mapping of IT events to IT computing resources. The KPI/IT event forecasting engine 1110 may generate forecasted IT failures/requirements 1114 based on the correlated IT computing resources affected by the predicted/forecasted IT events, and the type of IT events predicted/forecasted. The KPI/IT event forecasting engine 1110 also may generate forecasted organization process impacts based on the forecasted KPIs or changes in KPIs. These forecasts 1114 and 1116 may then be combined by logic of the runtime engine 1110 into a combined listing of IT events and KPI impacts based on forecasted resolve time (e.g., 6 hours from now vs. four hours from now). Again, while the focus is on IT events, as noted previously, these events may also include non-IT, or environmental, events such as weather, personnel, governmental/organizational events, and the like.

The impacted organization operations and IT computing resources in the list data structure 1118 may then be input to a remediation planner engine 1140 that automatically identifies remediation action recommendations and/or automatically initiates and executes remediation actions to mitigate predicted/forecasted unwanted KPIs, changes to KPIs, or IT events. In identifying these remediation actions, the IT resolution retrieval and ranking engine 1142 of the remediation planner engine 1140 may perform a lookup operation in an IT resolution database 1160, e.g., a site reliability engineering (SRE) database, of remedial actions that address different KPIs and/or IT events with regard to specific organizational processes and IT events, IT computing resources, and the like, specified in the listing data structure 1118. That is, for the KPI impacts and IT events, as well as their corresponding identified organizational processes/sub-processes and IT computing resources, in the listing data structure 1118, the IT resolution retrieval and ranking engine 1142 of the remediation planner engine 1140 performs a lookup operation in the IT resolution database 1160 for one or more entries of IT resolutions that match the pattern of these features from the listing data structure 1118 for each IT event and/or KPI impact. Scoring logic of the IT resolution retrieval and ranking engine 1142 may be used to score the entries that have some measure of matching so as to identify and rank the entries that have a matching characteristic and identify those that most likely match the particular IT events and/or KPI impacts specified in the listing data structure 1118, e.g., a highest scoring entry. If a matching entry is not found in the IT resolution database 1160, this lack of a matching entry may also be identified and used in generating the ranked order of IT resolutions 1170.

Having identified, by the IT resolution retrieval and ranking engine 1142, one or more matching entries in the IT resolution database 1160 for one or more of the IT events and KPI impacts specified in the listing data structure 1118, these remedial actions may be correlated with costs specified in a costs database, also referred to as a SRE cost database, 1150. That is, the SRE cost database 1150 specifies, for each remedial action in the IT resolution database 1160, a corresponding cost, where this cost may be based on resources needed to complete the remedial action, e.g., personnel costs, time and computing resource costs, costs due to unavailability of organizational processes and/or IT computing resources, etc. Thus, for each IT resolution identified by the IT resolution retrieval and ranking engine 1142 through the retrieval, scoring, and ranking, which may be a combination of a plurality of remedial actions, the remediation planner engine 1140 may retrieve a corresponding SRE cost by identifying the SRE costs, from the SRE cost database 1150, for each remedial action involved in the IT resolution retrieved from the IT resolution database 1160 for the one or more IT events and KPI impacts specified in the listing data structure 1118.

In scoring, ranking, and determining the costs of candidate remedial actions, the remediation planner engine 1140 may implement various impact analyzers 1144-1147 to determine scores, rankings, and costs based on expected resource allocations associated with the candidate remedial action, both with regard to organizational resources and IT related resources. The impact analyzers 1144-1147 may comprise machine learning models and/or operate in conjunction with ML computer models 1120, to perform analysis to determine impacts on operational processes and IT infrastructure for various types of resource allocations, thereby determining the amount of resources that should be allocated, or deallocated, from various organizational processes and/or IT infrastructure components, to achieve a maximum beneficial result to KPIs while minimizing costs.

For example, a first impact analyzer 1144 may evaluate the remedial action in accordance with organizational human staffing of impacted organization processes, e.g., determining how many organizational subject matter experts (SMEs) can be freed up from impacted organizational processes without worsening the severity of KPI impact based on experienced load on impacted organizational process steps. The load is a throughput KPI which may be determined by the KPI forecasting engine 1112 in FIG. 11, for example. The severity and duration of an impact may be obtained by the KPI forecasting engine 112 which identifies the anomalous pattern in the KPIs in the presence of events, e.g., IT events, and which is stored as part of the event-KPI causal model, e.g., 980 in FIG. 9. The determination of how many organizational SMEs can be freed up may be made by identifying impacted process steps, the duration of the impact, the severity of the impact, and the like, such as from an KPI impact profile and/or event-KPI causal model, e.g., 980 in FIG. 9, and use an objective function that maximizes KPI and resource utilization within the constraints of a resource pool from the impacted process step, the duration of the impact, the alternate/prescribed process steps, and the number of SMEs to be allocated, with decision variables being the allocation of tasks to SMEs.

As a non-limiting example, the first impact analyzer 1144 may implement a machine learning model, such as a linear regression based computer model, which considers the numerical variables representing load data per process step (1) and severity of KPI impact (s) as an input variable in a vector form x=[1, s] which is a concatenation of the load and severity values. The output of this machine learning model is a numerical variable representing the number of SMEs per process step in a vector form (y). Hence the machine learning model of the first impact analyzer 1144 learns a function y=Ax where A is a parameter matrix which maps an input vector x to the output variable y. This can be solved, for example, using the least squares formula A=(x^{T}x)⁻¹x^{T}y. Once an estimate of A is obtained using offline data through a machine learning process, different values of y corresponding to different values of x may be determined during runtime operation. That is, having a value of the number of SMEs in a process step, e.g., y1 from the ERP system, using the current values of KPI impact severity S and load data L, the trained machine learning model of the first impact analyzer 1144 may obtain another value y2 which represents the ideal number of SMEs for the process step under the current conditions. Usually, y2 will be less than y 1 since currently the KPIs are low and thus, a number of SMEs that can be freed up from the impacted process step may be obtained as y3=y2−y1, for example.

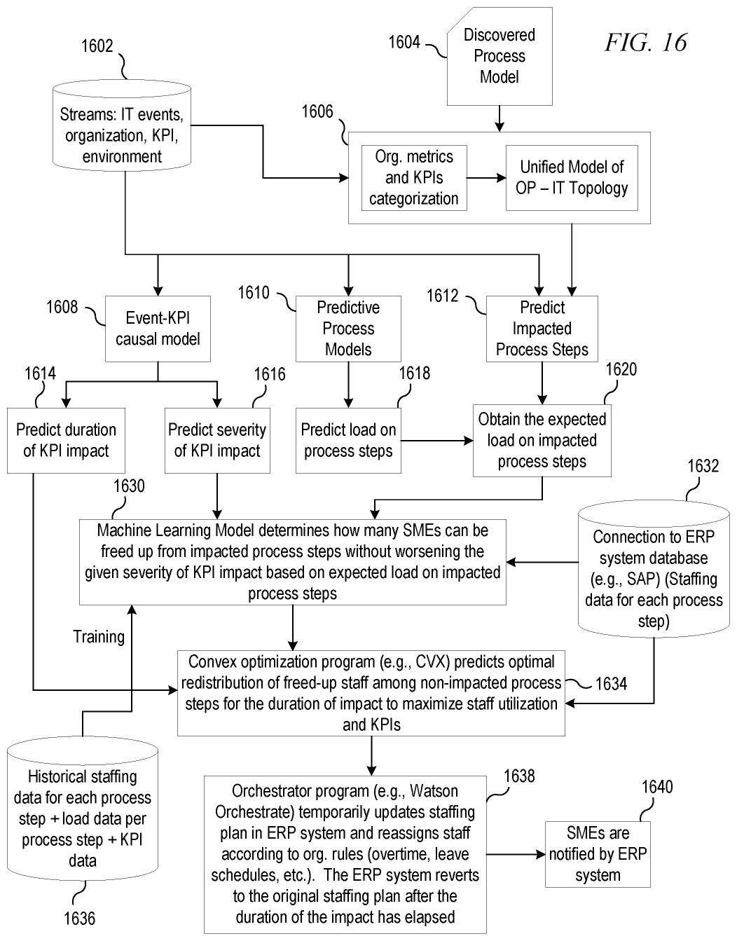

Now considering an optimization of the above, for n healthy process steps, there is a set of decision variables x1, x2, . . . , xn representing the number of SMEs to be allocated to each healthy process step. A constraint x1+x2+ . . . +xn=y3 may be generated, such as part of operation 1630 in FIG. 16 as described hereafter. This is because the total number of allocated SMEs is the same as the number of SMEs freed up. This constraint may be represented as H(x)=0. Using a linear regressor, such as in operation 1638 of FIG. 16 described hereafter, an ideal number of SMEs x1′, x2′, . . . xn′ required in other process steps for maintaining desired KPI levels as well as the current values x1″, x2″, . . . xn″ may be obtained, thereby obtaining the deficit values x1′″=x1′−x1″, x2′″=x2′−x2″, . . . , xn″′=xn′−xn″. Then a second set of constraints x1<=x1′″, x2<=x2′″, . . . xn<=xn″′ which we can represent as G(x)<=0 may be obtained. This is because the allocated SMEs should not exceed the requirement for each process step. Ideally, the allocations x1, x2 . . . xn should be as close as possible to the SME deficiencies x1′″, x2′″ . . . xn″′ to maximize organization KPIs. This can be achieved by minimizing an objective function F(x)=|x1−x1″′|²+|x2−x2″′|²+ . . . +|xn−xn″′|².

Hence the optimization problem becomes minimize F(x) subject to G(x)<=0 and H(x)=0. To solve this optimization problem various tools may be utilized, such as CVX. As an alternative to these off-the-shelf tools which use interior point methods such as the Primal-Dual interior point method for non-linear optimization, in some illustrative embodiments a procedure referred to herein as genetic algorithms (GAs) may be utilized. Gas are search algorithms based on the mechanism of natural selection and natural genetics. The basic objective of natural genetics is the retention of fit genes and discarding of poor ones. In nature, weak and unfit species within their environment are faced with extinction by natural selection. The strong ones have greater opportunity to pass their genes to future generation. In the long run, species carrying the correct combination in their genes become dominant in their population. Sometimes, during the slow process of evolution, random changes may occur in genes. If these changes provide additional advantage in the challenge for survival, new species evolve from the old ones. Unsuccessful changes are eliminated by natural selection.

In GA terminology, a solution vector X is called an individual or a chromosome. Chromosomes are made of discrete units called genes. Each gene controls one or more features of the chromosome. GAs operate with a collection of chromosomes, called population, which are generated randomly. As the search proceeds, GA Operators, called selection or sometimes reproduction, returns the population which includes only fitter chromosomes, generation after generation, and eventually converges.

GA's two other Operators, to generate new solutions from existing ones, are crossover and mutation. In crossover, generally two chromosomes, called parents, are combined together to form new chromosomes, called offspring. The parents are selected from among existing chromosomes in the population with preference towards fitness, so that offspring is expected to inherit good genes which make the parent fitter. There are different crossover operators which are selected based on the way chromosomes are encoded. Single-point, two-point, Multipoint, uniform, arithmetic, ordered crossover, etc., are some examples. By iteratively applying the crossover operator, genes of good chromosomes are expected to appear more frequently in the population, eventually leading to convergence to an overall good solution.

The mutation operator introduces random changes into characteristics of chromosomes. Mutation is generally applied at the gene level. In some GA implementations, the mutation rate (probability of changing the properties of the gene) is very small and depends on the length of the chromosome. Therefore, the new chromosome produced by mutation will not be very different from the original one. Mutation plays a critical role in GA. Crossover leads the population to converge by making the population alike. Mutation reintroduces genetic diversity back into the population and assists the search escape from local optima. There are many different forms of mutation for different kinds of representation. Flipping, Interchanging, Reversing Gaussian, Boundary, uniform and non-uniform are some examples of the mutation operators. Selection of chromosomes for the next generation is based on the fitness of an individual. There are different selection procedures in GA depending on how the fitness values are used. Examples of methods used for selecting chromosomes to crossover are Roulette wheel selection, Boltzmann selection, Proportional selection, ranking and tournament selection.

Upon application of such operators on the population, there is a chance that best chromosomes may be lost when a new population is created by crossover and mutation. In such cases the use of Elitism, which recommends the best chromosomes be copied to the new population, may be utilized to minimize such losses.

In some illustrative embodiments, the procedure of GA is as follows:
Step 1: Set t=1. Randomly generate N solutions to form the first population, Pₜ. Evaluate the fitness of solutions in Pₜ. A solution is unfit if it is infeasible, i.e., if it violates the constraints G(x)<=0 and H(x)=0. If it satisfies these constraints, then the lower the minimization objective F(x), the fitter the solution. Hence a possible measure of fitness could be negative infinity if the constraints are violated, and −F(x) if the constraints are satisfied.
Step 2: Crossover-Generate an offspring population Qₜ as follows:
   2.1. Choose two solutions x and y from Pₜ based on the fitness values.
   2.2. Using a crossover operator, generate offspring and add them to Qₜ.
Step 3: Mutation-Mutate each solution x ε Qₜ with a predefined mutation rate.
Step 4: Fitness assignment-Evaluate and assign a fitness value to each solution x ε Qₜ based on its objective function value and infeasibility as described above.
Step 5: Selection-Select N solutions from Qₜ based on their fitness and copy them to Pₜ₊₁.
Step 6: If the stopping criterion is satisfied (e.g., the objective function or fitness value does not change or changes very little), terminate the search and return to the current population, else, set t=t+1 and go to step 2.

A second impact analyzer 1145 may evaluate the remedial action in accordance with non-human organizational resource allocations, e.g., determining a quantum of organizational resources which can be deallocated from the resource allocation (e.g., quantity of shipping containers and freight space) without worsening the given severity of KPI impact based on expected cumulative load on resource allocation step for the duration of the load impact on the resource allocation step. The analyzer 1145 may determine impacted process steps upstream of a resource allocation step, the duration of the impact, and the severity of the impact, and compute the cumulative impact on the resource allocation step and the duration of the impact, such as by using a Gantt chart for the process model, for example. The second impact analyzer 1145 may execute a multiple linear regression on the Gantt chart and delay or reduce resource allocation for the duration of impact, or until the cumulative impact on the current process step is absorbed. The severity of the impact determines the quantum of resources to be deallocated, e.g., more severe the impact, the more resources are deallocated.

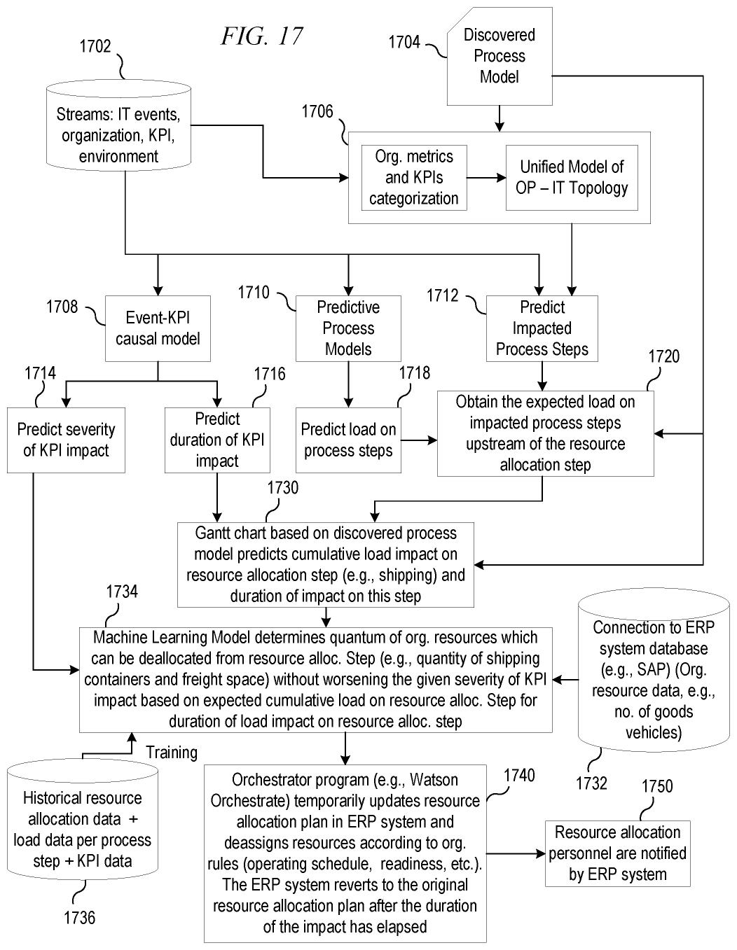

For example, in one illustrative embodiment (such as part of step 1734 in FIG. 17 as discussed hereafter), a multiple linear regression model similar to that described in step 1144 obtains a number of organizational resources, such as number of shipping containers (y1), warehouse space (y2), goods vehicles (y3) etc. that are ideally necessary for the resource allocation process step as a function of the load (1) and severity of KPI impact (s) on the resource allocation step. This is of the form y1=A₁x, y2=A₂x, y3=A₃x etc. where x=[1, s] is a concatenation of the load and severity values. The severity of KPI impact (s) is in this case the cumulative severity obtained from the Gantt chart 1730. It is known what the current load L on the resource allocation step is, such as from the CMDB, and current severity S of the KPI impact from the Gantt chart 1730. Hence, the current requirements yc, ys, yr etc. may be obtained for the resource allocation step by substituting x=[L, S] in the above equations. It is also known what the currently allocated resources y1′, y2′, y3′ etc. are, such as from the ERP system (e.g., SAP), where usually y1′>y1, y2′>y2, y3′>y3 and so on since the requirement is low currently due to the impact of the IT and environmental anomalies on the upstream process steps. Hence, the quantum of surplus resources of each type is obtained as y1″=y1′−y1, y2″=y2′−y2, y3″=y3′−y3, etc. These surplus resources should be deallocated from the resource allocation step for the duration of the cumulative KPI impact obtained from the Gantt chart. Alternatively, if these surplus resources are simply provisioned but not yet physically allocated, then for the duration of the cumulative KPI impact obtained from the Gantt chart, the allocation of these surplus resources should be delayed.

A third impact analyzer 1146 may evaluate the remedial action in accordance with specifically IT human resources, e.g., determining how many IT SREs are needed for fixing current IT issues to bring the KPIs back to normal levels within the duration of the KPI impact. The impact analyzer 1146 may determine the impacted KPIs, the duration of the impact, the severity of the impact, and the expected time and cost to resolve the IT issues. A constrained optimization operation is performed on these factors to determine, based on data specifying available resources, an allocation of IT SREs and a schedule of IT resolution activities in a manner that maximizes an amount of KPI impact being mitigated in a shortest amount of time within a specified budget.

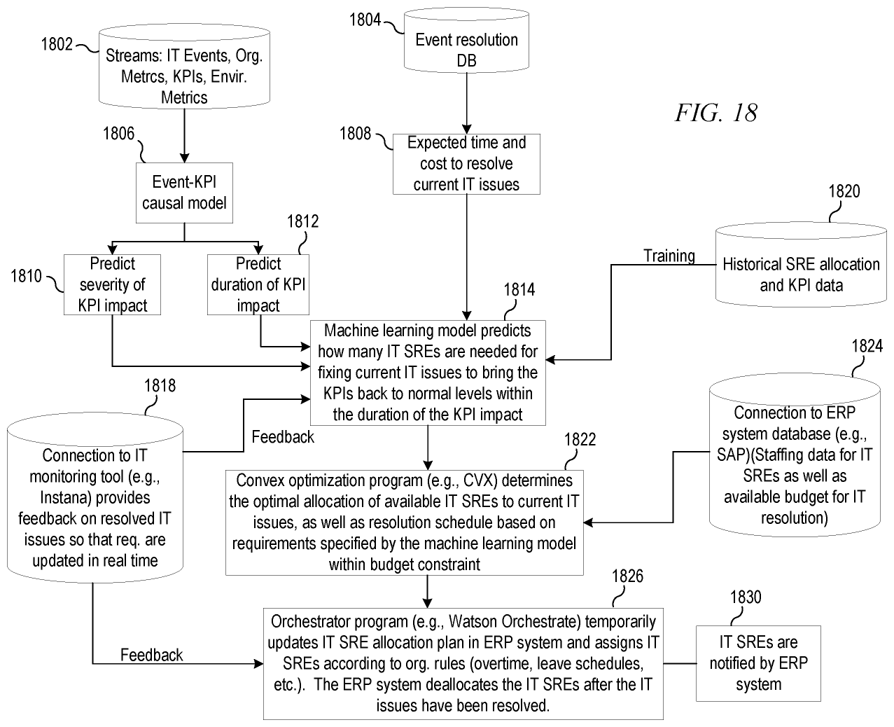

For example, the operation of the third impact analyzer 1146 may be similar to the impact analyzer 1144. In this case, with reference to FIG. 18, and step 1814 as discussed hereafter, a machine learning computer model, such as a linear regression model as described previously (e.g., such as used in step 1630 of FIG. 16) obtains the number of IT SREs that are necessary for addressing each IT issue (y) as a function of the time (t) required to resolve the issues, as well as the severity (s) of the issues. This is of the form y=Ax where x=[t, s] is a concatenation of the time and severity values. The current duration T and current severity S of the KPI impact is known from the event-KPI causal model, e.g., 980 in FIG. 9, 1180 in FIG. 11, or the like, e.g., see also FIG. 10 where events and corresponding KPIs are shown to be affected by these events. Let the current budget be B and the cost per SRE for the time duration T be C. For n IT issues, the number of SREs required to solve the issues corresponding to time of resolution T and severity S from the linear regression model are obtained as y1, y2, . . . , yn. In step 1822 of FIG. 18, a similar constrained optimization problem as in step 1638 of FIG. 16 is solved, in a similar manner as described previously.

That is, let x1, x2, . . . xn be the actual numbers of allocated SREs. Then for fully utilizing the budget, x1+x2+ . . . +xn=B/C. This constraint can be represented as H(x)=0. Also, since one does not want to over-allocate SREs to any IT issue, the constraint x1<=y1, x2<=y2 . . . xn<=yn is utilized. This constraint can be represented as G(x)<=0. In order to mitigate the maximum amount of KPI impact, one wants to minimize the deficiencies in IT SREs for each IT issue. This can be achieved by minimizing a function F(x)=|x1−y1|²+|x2−y2|²+ . . . +|xn−yn|². Hence, the optimization problem is minimize F(x) subject to G(x)<=0 and H(x)=0. This can be solved by using CVX or the Genetic Algorithm (GA) procedure outlined above.

A fourth impact analyzer 1147 may evaluate the remedial action in accordance with allocation of IT resources, e.g., determining a quantum of IT resources which can be freed up from impacted organizational process steps without worsening the given severity of KPI impact based on expected load on impacted process steps. The impact analyzer 1147 may determine the impacted process steps, the impacted KPIs, the duration of the impact, the severity of the impact, and a risk exposure, in monetary units, of process steps due to anomalies, e.g., failures. A constrained optimization operation is executed on these factors to determine a reallocation of IT infrastructure to organizational process steps that are upstream of the impacted process step for the duration of the impact in such a manner that the maximum amount of KPI impact is mitigated and the total risk exposure is minimized (assuming more infrastructure means less risk). The severity of the impact may be used to determine the quantum of resources to be reallocated, e.g., more severe impact means more resources will be allocated.

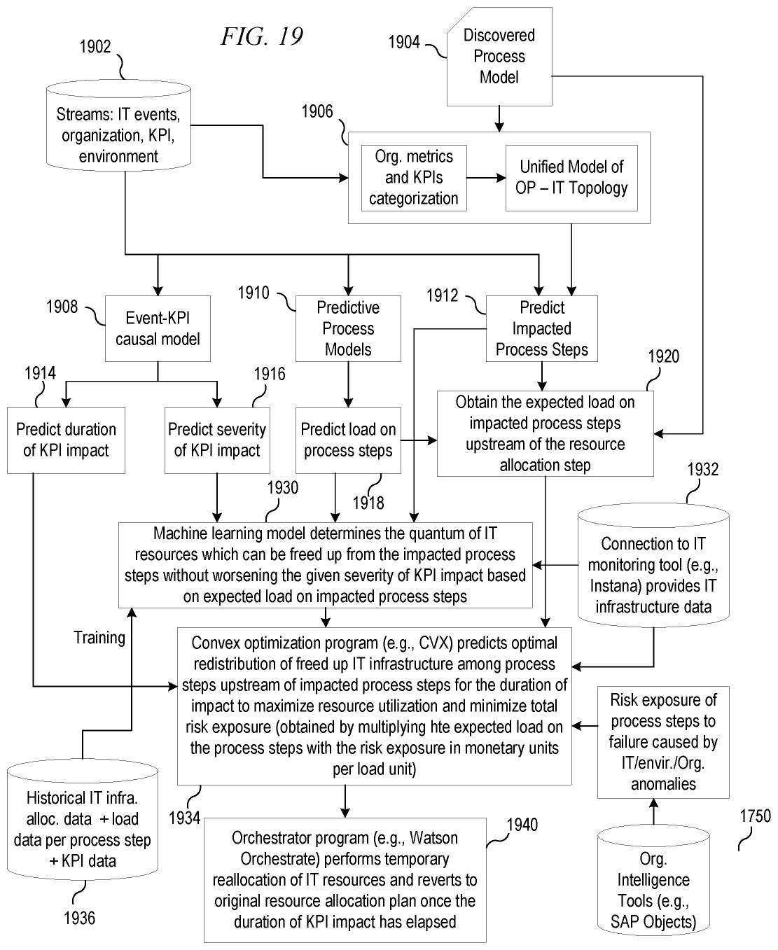

For example, in one illustrative embodiment, this fourth impact analyzer 1147 may operate similar to the impact analyzer 1144. With reference to FIG. 19, described hereafter, in step 1930, for example, a machine learning computer model, such as a multiple linear regression model similar to that described above with regard to the impact analyzer 1144, obtains the number of IT resources such as number of CPU cores (yc), hard disk space (ys), RAM size (yr) etc. that are ideally necessary for running each microservice representing a process step as a function of the load (l) and severity of KPI impact (s) on the microservice. This is of the form yc=A_{c}x, ys=Aₛx, yr=Aᵣx etc. where x=[1, s] is a concatenation of the load and severity values. It is known what the current load L on the impacted microservice is, such as from the CMDB, and it is further known what the current severity S of the KPI impact is from the event-KPI causal model (see step 1908 in FIG. 19). Hence, the current requirements yc, ys, yr etc. for the impacted microservice are obtained by substituting x=[L, S] in the above equations. It is also known what the currently allocated resources yc′, ys′, yr′ etc. are from the CMDB, where usually yc′>yc, ys′>ys, yr′>yr since the resource requirement is less due to the reduced load. Hence, one obtains the surplus resources as yc″=yc′−yc, ys″=ys'−ys, yr″=yr′−yr. For n healthy process steps, using the same regression model, one can derive the quantum of each resource e.g., CPU cores y1, y2, . . . , yn required by the healthy process steps under the current load by setting the KPI severity s=0 in the corresponding equations for each healthy process step. One can then obtain the currently allocated resources y1′, y2′, . . . yn′ from the CMDB and hence obtain the resource deficits for each healthy process step as y1″=y1−y1′, y2″=y2−y2′, . . . , yn″=yn−yn′.

In step 1934 of FIG. 19, for example, a similar constrained optimization problem is solved, as previously discussed with regard to step 1638 in FIG. 16. For n healthy process steps, let x1, x2, . . . xn be the quanta of a single resource (e.g., number of CPU cores) to be allocated to each healthy process step. Then, for fully utilizing the surplus resources, one has x1+x2+ . . . +xn=yc“. This can be represented as the constraint H(x)=0. Since one does not want to over-allocate CPU cores to any process step, the additional constraint x1<=y1″, x2<=y2″, . . . , xn<=yn” is utilized. This may be represented as the constraint G(x)<=0.

Let R1, R2, . . . , Rn be the Risk Exposure estimates of each of the healthy process steps. In order to maximize organization KPIs and minimize total Risk Exposure, one wants to minimize the resource deficits for each healthy process step weighted by their Risk Exposure. This can be achieved by minimizing a function F(x)=R1*|x1−y1″|²+R2*|x2−y2″|²+ . . . +Rn*|xn−yn″|². Hence, the optimization problem is minimize F(x) subject to G(x)<=0 and H(x)=0. This can again be solved by using CVX or the Genetic Algorithm (GA) procedure outlined above.

In some illustrative embodiments, the impact analyzers may utilize a convex optimization program (e.g., CVX) to predict optimal allocation and/or deallocation of resources. For example, convex optimization programs may be implemented to predict optimal redistribution of freed-up staff among non-impacted process steps for the duration of impact to maximize staff utilization and organizational KPIs. Such convex optimization programs may also be implemented to predict the optimal set of resources to be allocated/deallocated to minimize net operating costs so that more costly resources are deallocated first (e.g., shipping vehicles with higher freight charges being preferentially deallocated). Such convex optimization programs may be implemented to predict the optimal allocation of available IT SREs to current IT issues. Moreover, the convex optimization programs may also be implemented to predict the optimal redistribution of freed-up IT infrastructure among process steps upstream of impacted process steps for the duration of impact to maximize resource utilization and minimize total risk exposure (obtained by multiplying the expected load on the process steps with the risk exposure in monetary units per load unit).

The predicted impact of the identified remedial actions, or interventions, may be generated using the trained ML computer models 1120 to predict the IT events and/or KPIs, or changes in KPIs, and then having the KPI/IT event forecasting engine 1112 generate and list in the listing data structure 1118, the corresponding IT failures, IT requirements, organizational process impacts, and the like. In addition, the impact analyzers 1144-1147 may operate in conjunction with the ML computer models 1120 to determine the predicted impacts with regard to various resource allocations. Thus, these predictions provide an indication of what will occur if there is not remedial action performed, i.e., no IT resolution. Extrapolation logic of the remediation planner engine 1140 may extrapolate these predictions/forecasts for a predetermined time period in the future. For example, a linear extrapolation may be used that assumes that the condition will progress along the same line of metrics, KPIs, etc., predicted/forecasted by the ML computer models 1120, such as by using a linear regression based analysis.

Similarly, the remediation planner engine 1140 may estimate the impact of a remediation action or IT resolution on these same metrics, KPIs, or the like. The impact analyzers 1144-1147 and ML computer models 1120 may likewise be utilized with differing inputs corresponding to the remedial action to perform a “what-if” type impact analysis. In some illustrative embodiments, this is done by performing a counterfactual analysis of resolving the IT issue. The counterfactual analysis can be done by simulating the data with the value of IT events that would result when the IT resolution is performed. For example, adding storage space would reset the value of the IT metric “High disk space” to zero. Hence, the input to KPI/IT event forecasting engine 1112 would have all the other IT and OP KPIs as-is with the exception of IT metrics that would change because of the IT resolution. The impact of the IT metric on the OP KPIs is then evaluated via the ML computer model(s) 1120.

For example, a counterfactual analysis by counterfactual analysis logic 1148 of the remediation planner engine 1140 may evaluate the performance impact, as may be measured by various metrics including the KPIs, on the organizational processes, and the corresponding costs associated with the remedial action or IT resolution. IT resolution ranking logic 1149 may then rank the remedial actions/IT resolutions based on their expected performance impact and corresponding costs using any suitable ranking logic. For example, a cost-benefit analysis may be performed by the IT resolution ranking logic 1149 to rank remedial actions and IT resolutions based on maximum benefit with minimal cost type analysis. The result is a ranked order of remedial actions and/or IT resolutions 1170 that may be output to appropriate authorized personnel, such as IT teams or the like, so that they may prioritize their efforts in resolving issues based on this ranked ordering 1170. Each of the remedial actions in the ranked order of IT resolutions 1170 may have corresponding resource allocations for organizational resources and/or IT resources, which may include both human and non-human resources.

In some cases, the remedial actions and/or IT resolutions specified in the ranked ordering 1170 may be automatically initiated and executed to address the predicted IT/KPI issues based on the generated remedial action recommendations. For example, the ranked ordering 1170 may be output to management systems, such as management computing systems associated with the source computing systems 962-964 in FIG. 9, and those remedial actions and/or IT resolutions that are able to be automatically implemented may be automatically initiated and executed by these management computing systems. For example, the IT resolution database 1160, in addition to other characteristics of remedial actions and IT resolutions, may include indicators specifying whether or not the remedial action/IT resolution can be automatically initiated and executed, and may include computer code, pointers to computer code or applications, scripts, and the like, to facilitate automated initiation and execution of the remedial actions/IT resolutions. These indicators, code, scripts, pointers, or the like, may be included in the ranked order 1170 that is provided to the management computer systems which may then use these indicators, code, applications, scripts, pointers, or the like, to automatically initiate and execute remedial actions and IT resolutions specified as capable of automatic implementation. In some illustrative embodiments, platforms such as RedHat Ansible or Rundeck, may be used that allow for automated execution of remediations. These tools allow for executing the scripts automatically by linking them to specific IT resolutions in the IT resolution DB 1160.

In some illustrative embodiments, automatic implementation of the remedial action may involve an orchestrator program, e.g., IBM Watson Orchestrate, temporarily updating resource allocations plans in an Enterprise Resource Planning (ERP) system so as to reassign organizational staff, IT SREs, organizational and IT resources, deallocate staff and resources, or the like, in accordance with organizational and IT allocation rules, e.g., Ansible playbook(s), so as to maximize beneficial results on KPIs, maximize resource utilization, and minimize risk and costs. The ERP system may revert to the original resource allocation plan after the duration of the KPI impact has elapsed.

Thus, the illustrative embodiments provide an improved computing tool and improved computing tool operations/functionality that specifically trains one or more machine learning computer models to predict/forecast KPIs, changes in KPIs, and IT events, and correlates these predictions with IT computing resources and organizational performance operations using correlation graph data structures to thereby forecast the impact of such KPIs, changes in KPIs, and IT events on an organization and its IT infrastructure. The illustrative embodiments provide automated computing tools to perform such predictions and forecasts and identify remedial action recommendations to address unwanted impacts on the organization and its IT infrastructure. The illustrative embodiments provide automated computing tools to rank such remedial action recommendations and in some cases automatically initiate and execute the relatively highest ranking remedial action recommendations. Moreover, these operations are performed based on machine learning learned correlations between organizational performance operation metrics, such as KPIs, and underlying IT events. The ranking of remedial action recommendations takes into account the predicted benefit to the organization and its IT infrastructure versus the predicted costs so as to prioritize and focus organization and IT resources to those remedial actions that are of the most benefit with least cost.

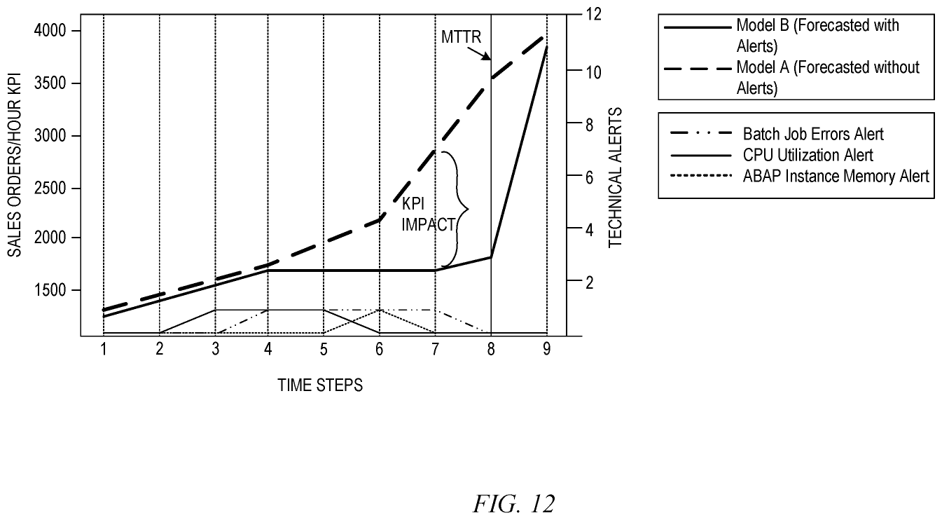

FIG. 12 is an example diagram showing a correlation of OP operation metrics with IT events over time and the determination of a key performance indicator impact based on such a correlation, in accordance with one illustrative embodiment. Here, the model assesses the KPI impact by the counterfactual analysis. The Model B represents the forecast of the KPI given the different IT alerts. At timestep 4, a Batch Job Error alert occurs. As per the model B, the KPI does not increase and remains constant. Model A forecasts the counterfactual KPI value where the Batch Job Error has not occurred. As can be seen in FIG. 12, the forecast of the Model A indicates the KPI constantly increasing. The difference between these two lines: solid (Model B) and dashed (Model A) is the KPI impact at that time step. In this example, the KPI impact is also shown, which can be computed based on the information in an IT resolution DB. If the error takes 4 hours to resolve, this information can be used as input to the model to identify the impact on the KPI.

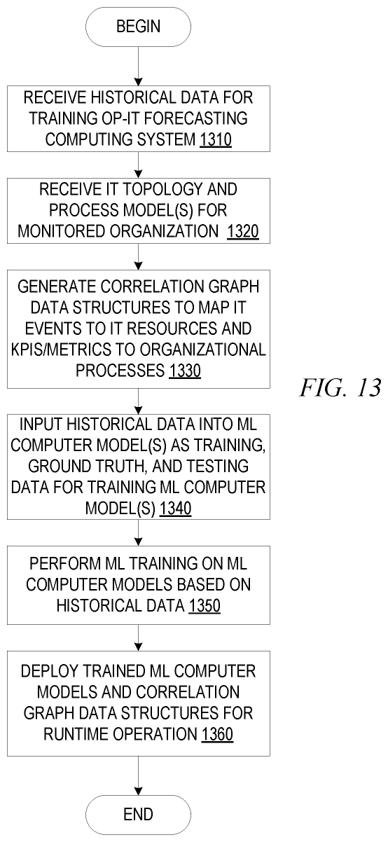

FIGS. 13-15 present flowcharts outlining example operations of elements of the present invention with regard to one or more illustrative embodiments. It should be appreciated that the operations outlined in FIGS. 13-15 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 13-15, and may, in some cases, make use of the results generated as a consequence of the operations set forth in FIGS. 13-15, the operations in FIGS. 13-15 themselves are specifically performed by the improved computing tool in an automated manner.

FIG. 13 is a flowchart outlining an example operation for performing offline training of the OP-IT forecasting computing system in accordance with one illustrative embodiment. As shown in FIG. 13, the operation starts by receiving historical data for training the OP-IT forecasting computing system (step 1310). This historical data may comprise logs and other data captured by IT monitoring, environmental monitoring, and organizational process monitoring computing systems that operate as data source computing systems for the OP-IT forecasting computing system. In addition to the historical data, the IT topology and process models for the monitored organization and IT infrastructure are obtained (step 1320). The historical data, IT topology, and process models are input to the correlation engine(s) which generate correlation graph data structures (step 1330). As described above, these correlation graph data structures map IT events to IT computing resources and process metrics and/or KPIs to organizational processes and sub-processes.

The historical data is also input to one or more ML computer models as training data (step 1340). A ML training operation is performed on the one or more ML computer models to train the ML computer models to generate predictions/forecasts of IT events and/or KPIs given a pattern of input data representing IT events, process metrics, KPIs, and the like (step 1350). For example, a first ML computer model may be trained on such historical data, which may be used to provide training data, ground truth, as well as testing data for the ML training operation, to generate predictions/forecasts of IT events while a second ML computer model may be trained to generate predictions/forecasts of KPIs. The resulting trained ML computer model(s) and correlation graph data structures are deployed for use in evaluating runtime data streams of IT events, metrics, KPIs, and the like (step 1360) and the operation terminates.

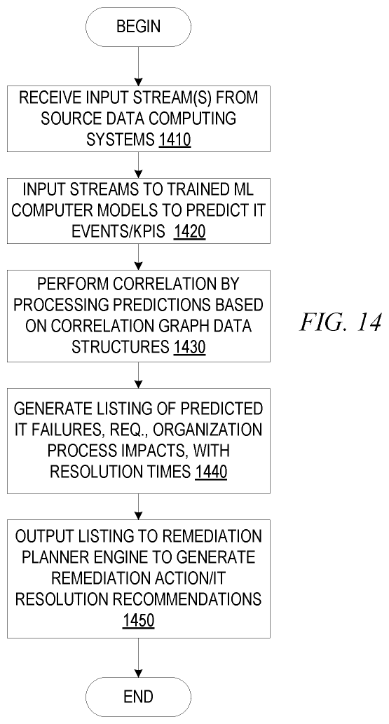

FIG. 14 is a flowchart outlining an example operation for performing online forecasting by way of the OP-IT forecasting computing system in accordance with one illustrative embodiment. The operation outlined in FIG. 14 assumes a training of the OP-IT forecasting computing system components, such as described previously, and also outlined in FIG. 13, for example. The operation starts by receiving one or more input streams of data, such as may represent IT events, organizational process metrics, KPIs, environmental metrics, and the like, from source data computing systems (step 1410). These streams of data are input to the trained ML computer model(s) which predict corresponding IT events and KPIs based on the input data and in accordance with their training (step 1420). The predicted IT events and KPIs are processed by applying correlation graph data structures to the IT events and KPIs to identify forecasted IT failures, requirements, and organizational process impacts by correlating IT events and KPIs with corresponding IT computing resources and organizational processes and sub-processes (step 1430). The forecasted IT failures, requirements, and organization process impacts are compiled into a listing data structure that specifies corresponding the corresponding IT events, IT computing resources affected, organizational processes affected, KPI impacts, and the like, along with corresponding estimated resolution times (step 1440). The listing data structure is then output to a remediation planner engine (step 1450) to generate remediation action/IT resolution recommendations for output to appropriate authorized personnel, e.g., IT teams, and/or for automated initiation and execution. The operation then terminates.

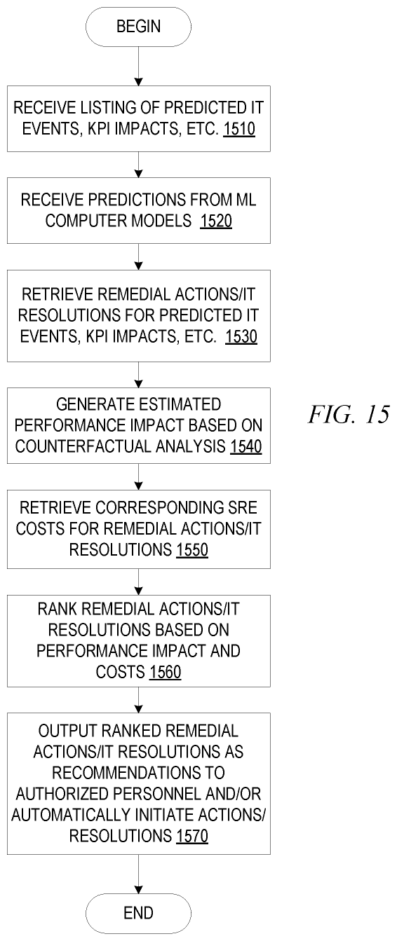

FIG. 15 is a flowchart outlining an example operation for performing remediation action planning based on forecasting from an OP-IT forecasting computing system in accordance with one illustrative embodiment. As shown in FIG. 15, the operation starts by receiving a listing data structure that identifies the IT events, KPI impacts, and the like, as may be generated through the operation of FIG. 14, for example (step 1510). In addition, the remediation action planning operation also receives as input, the predictions of IT events and KPIs generated by the ML computer models (step 1520). A lookup of the remedial actions and/or IT resolutions corresponding to the IT events and/or KPI impacts is performed to identify, for one or more of the IT events and/or KPI impacts, corresponding remedial actions/IT resolutions that address unwanted conditions (step 1530). An estimated performance impact for the remedial actions/IT resolutions is generated, such as by performing a counterfactual analysis (step 1540) and corresponding SRE costs are retrieved from an SRE costs database (step 1550). The remedial actions/IT resolutions are ranked based on ranking logic, which may implement a cost-benefit analysis based on the SRE costs and estimated performance impacts, for example (step 1560). The ranked order of remedial actions/IT resolutions may then be output to authorized personnel, e.g., IT teams, to prioritize application of personnel and IT resources to addressing the IT events that are most impactful on the performance of the organization, such as may be measured by KPIs (step 1570). In some cases, although not depicted in FIG. 15, the ranked ordering may also be output for automated initiation and execution of remedial actions/IT resolutions via corresponding monitoring and IT infrastructure management computing systems. The operation then terminates.

FIG. 16 is a flowchart outlining an example operation for performing organizational staff allocation based on predicted OP and KPI impacts in accordance with one illustrative embodiment. As shown in FIG. 16, an event stream, organizational metric stream, KPI stream, and environment metrics stream is received from monitoring tools (step 1602) along with organizational process model(s) (step 1604) for an organizational process that is to be evaluated (see FIG. 8 as an example of a process model). From the input streams and organizational process model, organizational metrics and KPIs are categorized and used to generate a unified model of the OP-IT topology (step 1606). Based on the input streams (step 1602), an event-KPI causal model (step 1608), predictive process models (step 1610), and predicted impact process steps (step 1612) are generated. The predicted impact process steps may be identified, for example s part of the output of the IT event to resource correlation engine 914 where the resource is a process step, and may be similar to the forecasted process impacts 1116. From the event-KPI causal model, a predicted duration of KPI impact (step 1614) and predicted severity of the KPI impact (step 1616) are generated. From the predictive process models (step 1610), the load on the process steps is determined (step 1618). Based on the unified model of OP-IT topology and the input streams, predicted impacted process steps are identified (step 1612) which is combined with the predicted load on process steps (step 1618) to determine the expected load on impacted process steps (step 1620).

Based on the predicted severity of KPI impact (1616), expected load on impacted process steps (1620), and data from a connected ERP system database (1632), machine learning model(s) determine how many organizational SMEs can be freed up from impacted process steps without worsening the given severity of KPI impact based on expected load on impacted process steps (step 1630). The machine learning models are trained based on historical staffing data for each process step, load data per process step, and KPI data (step 1636).

An optimal redistribution of freed-up staff among non-impacted process steps is determined, for the duration of impact, to maximize staff utilization and KPIs (step 1634). As an example, a convex optimization program, e.g., CVX, can be used to predict the optimal redistribution. Based on the optimal redistribution, an orchestrator program, e.g., IBM Watson Orchestrate, temporarily updates the staffing plan in the ERP system and reassigns staff according to organizational rules (e.g., overtime, leave schedules, etc.) (step 1638). The ERP system will revert to the original staffing plan after the duration of the impact has elapsed. The organizational SMEs are then notified by the ERP system (step 1640). The operation then terminates.

FIG. 17 if a flowchart outlining an example operation for allocating non-human organizational resources based on predicted OP and KPI impacts in accordance with one illustrative embodiment. As shown in FIG. 17, an event stream, organizational metric stream, KPI stream, and environment metrics stream is received from monitoring tools (step 1702) along with organizational process model(s) (step 1704) for an organizational process that is to be evaluated (see FIG. 8 as an example of a process model). From the input streams and organizational process model, organizational metrics and KPIs are categorized and used to generate a unified model of the OP-IT topology (step 1706). Based on the input streams (step 1702), an event-KPI causal model (step 1708), predictive process models (step 1710), and predicted impact process steps (step 1712) are generated. From the event-KPI causal model, a predicted duration of KPI impact (step 1716) and predicted severity of the KPI impact (step 1714) are generated. From the predictive process models (step 1710), the load on the process steps is determined (step 1718). Based on the unified model of OP-IT topology and the input streams, predicted impacted process steps are identified (step 1712) which is combined with the predicted load on process steps (step 1718) and process model (step 1704) to determine the expected load on impacted process steps (step 1720).

Based on the predicted duration of KPI impact (1716), expected load on impacted process steps (1720), and the process model (1704), a Gantt chart may be generated which is used to predict cumulative load impact on resource allocation and duration of the impact (step 1730). The output of the Gantt chart along with the predicted severity of KPI impact (1714), and data from the connected ERP system (step 1732), are fed as input to one or more machine learning models which determine a quantum of organizational resources which can be deallocated from the resource allocation step (e.g., quantity of shipping containers and freight space), without worsening the given severity of KPI impact based on expected cumulative load on the resource allocation step for the duration of load impact on the resource allocation step (step 1734). The machine learning models are trained based on historical staffing data for each process step, load data per process step, and KPI data (step 1736).

Based on the recommendation from the machine learning models, an orchestrator program, e.g., IBM Watson Orchestrate, temporarily updates the organizational resource allocation plan in the ERP system and assigns organizational resources according to organizational rules (e.g., operating schedule, readiness, etc.) (step 1740). The ERP system will revert to the original organizational resource allocation plan after the duration of the impact has elapsed. The organizational SMEs are then notified by the ERP system (step 1750). The operation then terminates.

FIG. 18 is a flowchart outlining an example operation for allocating IT SREs based on predicted OP and KPI impacts in accordance with one illustrative embodiment. As shown in FIG. 18, an event stream, organizational metric stream, KPI stream, and environment metrics stream is received from monitoring tools (step 1802). Event resolution database data is also received (step 1804). Based on the input streams, an event-KPI causal model operates on the inputs (step 1806) and used to predict severity of KPI impact (step 1810) and duration of the KPI impact (step 1812). Based on the input streams and the event resolution database input, an expected time and cost to resolve a current IT issue is determined (step 1808). The predicted severity, predicted duration, expected time and cost to resolve, historical SRE allocation and KPI data (step 1820) and IT monitoring tool data (step 1818) are input to one or more machine learning models (step 1814) which predict how many IT SREs are needed for fixing the current IT issues to bring the KPI back to normal levels within the duration of the KPI impact (step 1814).

An optimal allocation of available IT SREs to current IT issues, as well as resolution schedule based on requirements specified by the ML model within the budget constraint is determined (step 1822) based on the output from the ML models (step 1814) and ERP system data (step 1824). As an example, a convex optimization program, e.g., CVX, can be used to predict the optimal allocation. Based on the optimal allocation, an orchestrator program, e.g., IBM Watson Orchestrate, temporarily updates the IT SRE allocation plan in the ERP system and reassigns IT SREs according to organizational rules (e.g., overtime, leave schedules, etc.) (step 1826). The ERP system will revert to the original staffing plan after the duration of the impact has elapsed. The IT SREs are then notified by the ERP system (step 1830). The operation then terminates.

FIG. 19 is a flowchart outlining an example operation for allocating IT resources based on predicted OP and KPI impacts in accordance with one illustrative embodiment. As shown in FIG. 19, an event stream, organizational metric stream, KPI stream, and environment metrics stream is received from monitoring tools (step 1902) along with organizational process model(s) (step 1904) for an organizational process that is to be evaluated (see FIG. 8 as an example of a process model). From the input streams and organizational process model, organizational metrics and KPIs are categorized and used to generate a unified model of the OP-IT topology (step 1906). Based on the input streams (step 1902), an event-KPI causal model (step 1908), predictive process models (step 1910), and predicted impact process steps (step 1912) are generated. From the event-KPI causal model, a predicted duration of KPI impact (step 1914) and predicted severity of the KPI impact (step 1916) are generated. From the predictive process models (step 1910), the load on the process steps is determined (step 1918). Based on the unified model of OP-IT topology and the input streams, predicted impacted process steps are identified (step 1912) which is combined with the predicted load on process steps (step 1918) and process model (step 1904) to determine the expected load on impacted process steps (step 1920).

Based on the predicted severity of KPI impact (1916), expected load on impacted process steps (1918), and the predicted impacted process steps (1912), machine learning model(s) determine the quantum of IT resources which can be freed up from the impacted process steps without worsening the given severity of KPI impact based on expected load on impacted process steps (step 1930). The machine learning models are trained based on historical staffing data for each process step, load data per process step, and KPI data (step 1936).

An optimal redistribution of freed-up IT infrastructure among process steps upstream of the impacted process steps for the duration of impact is determined, to maximize resource utilization and minimize the total risk exposure (obtained by multiplying the expected load on the process steps with the risk exposure in monetary units per load unit) (step 1934). As an example, a convex optimization program, e.g., CVX, can be used to predict the optimal redistribution. Based on the optimal redistribution, an orchestrator program, e.g., IBM Watson Orchestrate, temporarily updates the allocation of IT resources, such as by using Ansible playbooks for example (step 1940). The IT system will revert to the original resource allocation plan after the duration of the impact has elapsed. The optimal redistribution of freed up IT infrastructure may be determined based on a risk exposure (step 1938) generated from organizational intelligent tools, e.g., SAP objects (step 1942). The operation then terminates.

From the above discussion, it is clear that the present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool.

In particular, the improved computing tool of the illustrative embodiments specifically provides an ITF impact prediction framework, correlation engine(s) and impact based resource allocation framework which learn, through machine learning processes, correlations between events and organizational processes and IT resources, so that predications/forecasts of the impact of events on the organizational processes, KPIs, and IT computing resources may be automatically generated and remedial actions identified, ranked, and presented to authorized personnel to respond to such predicated/forecasted situations, and in some cases automatically initiated and executed. The improved computing tool implements mechanism and functionality, such as the trained machine learning computer models, unified models, correlation graph logic, and the like, of the frameworks which cannot be practically performed by human beings either outside of, or with the assistance of, a technical environment, such as a mental process or the like. The improved computing tool provides a practical application of the methodology at least in that the improved computing tool is able to generate forecasts or predications based on machine learning learned correlations between events, organizational processes, IT resources, KPI metrics, and the like, and automatically identify remedial actions to address situations predicted/forecasted based on these learned correlations and perform resource allocations so as to maximize beneficial results on KPIs while minimizing costs.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
executing machine learning training of one or more machine learning (ML) computer models based on historical data representing logged events and key performance indicators (KPIs) of organizational processes, wherein the one or more ML computer models are trained to forecast a KPI impact given events in the input data;
generating at least one correlation graph data structure that maps at least one of events to IT computing resources, or KPI impacts to organizational processes;
generating a unified model of organizational processes and IT resources, wherein the unified model executes to predict affected IT resources given a KPI impact to an organizational process;
processing, by the one or more trained ML computer models and the unified model, input data to generate a forecast output, wherein the forecast output specifies at least one of a forecasted IT event or a forecasted KPI impact;
correlating the forecasted output with at least one of an IT computing resource or an organizational process, at least by applying the at least one correlation graph data structure to the forecast output to generate a correlation output; and
generating a remedial action recommendation based on the forecast output and correlation output, wherein the remedial action recommendation has an associated resource allocation.

2. The method of claim 1, wherein the at least one correlation graph data structure comprises an organizational process (OP) correlation graph data structure that correlates different types of OP operations with corresponding KPIs, and an IT correlation graph data structure that correlates an IT topology with corresponding IT events.

3. The method of claim 2, wherein correlating the forecasted output with at least one of an IT computing resource or an organizational process, comprises at least one of:
identifying, in the OP correlation graph data structure, at least one OP operation affected by the forecasted KPI impact; or
identifying, in the IT correlation graph data structure, at least one IT topology component correlated with the forecasted IT event.

4. The method of claim 1, wherein generating the unified model comprises:
determining key entities of a plurality of steps of a process performed by an information technology (IT) system;
grouping a plurality of application program interface (API) calls based on payload and temporal proximities of the API calls, and for corresponding service APIs, extracting key entities;
aligning the plurality of steps and service APIs;
determining key service APIs for the process steps; and
generating the unified model based on the determined key service APIs for the process steps.

5. The method of claim 1, wherein generating a remedial action recommendation comprises performing a lookup operation in a site reliability engineering database of remediation actions corresponding to at least one of the one or more IT computing resources or one or more organizational processes.

6. The method of claim 1, wherein generating a remedial action recommendation based on the forecast output and correlation output comprises:
executing one or more impact analyzers to predict a number of resources to allocate to one of IT systems or organizational process operations based on one or more machine learning computer model; and
executing, by an orchestrator computing tool, an allocation of the predicted number of resources to one of the IT systems or organizational process operations based on the prediction.

7. The method of claim 6, wherein the one or more impact analyzes comprises an organizational human staffing impact analyzer that predicts a number of organizational subject matter experts that can be freed up from impacted organizational processes without worsening a severity of the forecasted KPI impact.

8. The method of claim 6, wherein the one or more impact analyzers comprises a non-human organizational resource allocation impact analyzer that predicts a quantum of organizational resources that can be deallocated without worsening a severity of the predicted KPI impact based on an excepted cumulative load on a resource allocation operation.

9. The method of claim 6, wherein the one or more impact analyzers comprises an IT human resources allocation impact analyzer that predicts a number of Site Reliability Engineers needed to correct an IT issue and bring KPIs back to a predetermined level within a duration of the forecasted KPI impact.

10. The method of claim 6, wherein the one or more impact analyzers comprises an IT resources allocation impact analyzer that predicts a quantum of IT resources which can be freed from impacted organizational process operations without worsening a severity of the forecasted KPI impact.

11. A computer program product, comprising a computer readable storage medium having a computer readable program stored therein, wherein the computer readable program, when executed by a data processing system, causes the data processing system to:
execute machine learning training of one or more machine learning (ML) computer models based on historical data representing logged events and key performance indicators (KPIs) of organizational processes, wherein the one or more ML computer models are trained to forecast a KPI impact given events in the input data;
generate at least one correlation graph data structure that maps at least one of events to IT computing resources, or KPI impacts to organizational processes;
generate a unified model of organizational processes and IT resources, wherein the unified model executes to predict affected IT resources given a KPI impact to an organizational process;
process, by the one or more trained ML computer models and the unified model, input data to generate a forecast output, wherein the forecast output specifies at least one of a forecasted IT event or a forecasted KPI impact;
correlate the forecasted output with at least one of an IT computing resource or an organizational process, at least by applying the at least one correlation graph data structure to the forecast output to generate a correlation output; and
generate a remedial action recommendation based on the forecast output and correlation output, wherein the remedial action recommendation has an associated resource allocation.

12. The computer program product of claim 11, wherein the at least one correlation graph data structure comprises an organizational process (OP) correlation graph data structure that correlates different types of OP operations with corresponding KPIs, and an IT correlation graph data structure that correlates an IT topology with corresponding IT events.

13. The computer program product of claim 12, wherein correlating the forecasted output with at least one of an IT computing resource or an organizational process, comprises at least one of:
identifying, in the OP correlation graph data structure, at least one OP operation affected by the forecasted KPI impact; or
identifying, in the IT correlation graph data structure, at least one IT topology component correlated with the forecasted IT event.

14. The computer program product of claim 11, wherein generating the unified model comprises:
determining key entities of a plurality of steps of a process performed by an information technology (IT) system;
grouping a plurality of application program interface (API) calls based on payload and temporal proximities of the API calls, and for corresponding service APIs, extracting key entities;
aligning the plurality of steps and service APIs;
determining key service APIs for the process steps; and
generating the unified model based on the determined key service APIs for the process steps.

15. The computer program product of claim 11, wherein generating a remedial action recommendation based on the forecast output and correlation output comprises:
executing one or more impact analyzers to predict a number of resources to allocate to one of IT systems or organizational process operations based on one or more machine learning computer model; and
executing, by an orchestrator computing tool, an allocation of the predicted number of resources to one of the IT systems or organizational process operations based on the prediction.

16. The computer program product of claim 15, wherein the one or more impact analyzes comprises an organizational human staffing impact analyzer that predicts a number of organizational subject matter experts that can be freed up from impacted organizational processes without worsening a severity of the forecasted KPI impact.

17. The computer program product of claim 15, wherein the one or more impact analyzers comprises a non-human organizational resource allocation impact analyzer that predicts a quantum of organizational resources that can be deallocated without worsening a severity of the predicted KPI impact based on an excepted cumulative load on a resource allocation operation.

18. The computer program product of claim 15, wherein the one or more impact analyzers comprises an IT human resources allocation impact analyzer that predicts a number of Site Reliability Engineers needed to correct an IT issue and bring KPIs back to a predetermined level within a duration of the forecasted KPI impact.

19. The computer program product of claim 15, wherein the one or more impact analyzers comprises an IT resources allocation impact analyzer that predicts a quantum of IT resources which can be freed from impacted organizational process operations without worsening a severity of the forecasted KPI impact.

20. An apparatus comprising:
at least one processor; and
at least one memory coupled to the at least one processor, wherein the at least one memory comprises instructions which, when executed by the at least one processor, cause the at least one processor to:
execute machine learning training of one or more machine learning (ML) computer models based on historical data representing logged events and key performance indicators (KPIs) of organizational processes, wherein the one or more ML computer models are trained to forecast a KPI impact given events in the input data;
generate at least one correlation graph data structure that maps at least one of events to IT computing resources, or KPI impacts to organizational processes;
generate a unified model of organizational processes and IT resources, wherein the unified model executes to predict affected IT resources given a KPI impact to an organizational process;
process, by the one or more trained ML computer models and the unified model, input data to generate a forecast output, wherein the forecast output specifies at least one of a forecasted IT event or a forecasted KPI impact;
correlate the forecasted output with at least one of an IT computing resource or an organizational process, at least by applying the at least one correlation graph data structure to the forecast output to generate a correlation output; and
generate a remedial action recommendation based on the forecast output and correlation output, wherein the remedial action recommendation has an associated resource allocation.
